(19) United States
(12) Patent Application Publication
(10) Pub. No.: US 2025/0078788 A1
(43) Pub. Date: Mar. 6, 2025

(54) ELECTRONIC PERCUSSION INSTRUMENT AND NON-PERCUSSION SURFACE FORMING METHOD

(71) Applicant: Roland Corporation, Shizuoka (JP)

(72) Inventors: Rei NONOMURA, Shizuoka (JP); Ryo Tanida, Shizuoka (JP); Keita UTSUMI, Shizuoka (JP)

(73) Assignee: Roland Corporation, Shizuoka (JP)

(21) Appl. No.: 18/287,302

(22) PCT Filed: Jun. 14, 2023
(86) PCT No.: PCT/JP2023/022109

§ 371 Date: Oct. 18, 2023

(30) Foreign Application Priority Data
Jun. 23, 2022 (JP) 2022-100870

(51) Int. Cl. G10D 13/10; G10D 13/20

(52) U.S. Cl. CPC G10D 13/26; G10D 13/20

(57) ABSTRACT

A sensor for vibration detection is not installed to a second frame 301b, and an upper surface of the second frame 301b is a non-percussion surface not assumed to receive a percussion. Since the second frame 301b is elastically supported by the first frame 301a via the elastic bodies 309a to 309c, at the time of a percussion to a head 202 or a cover 206, the elastic bodies 309a to 309c can attenuate the vibration propagated from the first frame 301a to the second frame 301b. Thus, since the noise produced due to the vibration of the second frame 301b can be suppressed, the performer is allowed a favorable feeling of performance.

### TECHNICAL FIELD

The invention relates to an electronic percussion instrument and a non-percussion surface forming method, and particularly relates to an electronic percussion instrument and a non-percussion surface forming method capable of reducing noise produced at a time of a percussion to a percussion surface.

### RELATED ART

As an example, Patent Document 1 discloses an electronic percussion instrument including a percussed part 22 (first frame) supported by a support body 10 and a frame 44 (second frame) forming, together with the percussed part 22, a circular profile of the electronic percussion instrument. The upper surface of the percussed part 22 is a percussion surface 22 that receives a percussion. The vibration at the time of the percussion to the percussion surface 22a is detected by using a piezo sensor installed to a case 23 of a rear surface of the percussed part 22.

Meanwhile, a sensor is not installed to the frame 44, and the upper surface of the frame 44 is a non-percussion surface not assumed to receive a percussion. That is, the frame 44 is a frame for improving the appearance by forming, together with the percussed part 22, a disc shape (the shape of the upper surface or the profile) of the electronic percussion instrument.

### PRIOR ART DOCUMENT(S)

### Patent Document(s)

[Patent Document 1] Japanese Laid-open No. 2017-026726 (e.g., para. [0021], [0022], [0039], [0040]. FIGS. 1 to 3).

### SUMMARY OF INVENTION

### Technical Problem

However, in the conventional art, when the vibration at the time of the percussion to the percussed part 22 (first frame) is propagated to the frame 44 (second frame), an issue that noise is easily produced due to the vibration of the frame 44 itself, etc.

The invention has been made to solve the above issue, and an objective of the invention is to provide an electronic percussion instrument and a non-percussion forming method capable of reducing the noise produced at the time of the percussion to the percussion surface.

### Solution to Problem

In order to achieve the objective, an electronic percussion instrument according to the invention has, on an upper surface, a percussion surface that receives a percussion and a non-percussion surface that is not assumed to receive the percussion. The electronic percussion instrument includes: a sensor, detecting a vibration of the percussion to the percussion surface; a first frame, forming a skeleton of the percussion surface; an elastic body, fixed to the first frame; and a second frame, which is connected with the first frame via the elastic body, and to which a sensor is not installed. The non-percussion surface is formed by an upper surface of the second frame.

A non-percussion surface forming method according to the invention is a non-percussion surface forming method for an electronic percussion instrument having, on an upper surface, a percussion surface that receives a percussion and a non-percussion surface not assumed to receive the percussion. The electronic percussion instrument includes: a sensor, detecting a vibration of the percussion to the percussion surface; a first frame, forming a skeleton of the percussion surface; an elastic body, fixed to the first frame; and a second frame, which is connected with the first frame via the elastic body, and to which a sensor is not installed. In the non-percussion surface forming method, the non-percussion surface is formed by an upper surface of the second frame.

### BRIEF DESCRIPTION OF DRAWINGS

FIG. 1 is an exploded perspective view illustrating an electronic percussion instrument according to a first embodiment.

FIG. 2 is a partially enlarged cross-sectional view of the electronic percussion instrument.

FIG. 3 (a) of FIG. 3 is a cross-sectional view illustrating a rim according to a first modified example. (b) of FIG. 3 is a cross-sectional view illustrating a rim according to a second modified example. (c) of FIG. 3 is a cross-sectional view illustrating a rim according to a third modified example. (d) of FIG. 3 is a cross-sectional view illustrating a rim according to a fourth modified example, (e) of FIG. 3 is a cross-sectional view illustrating a rim according to a fifth modified example. (f) of FIG. 3 is a cross-sectional view illustrating a rim according to a sixth modified example.

FIG. 4 (a) of FIG. 4 is a cross-sectional view illustrating a rim according to a seventh modified example. (b) of FIG. 4 is a cross-sectional view illustrating a rim according to an eighth modified example. (c) of FIG. 4 is a cross-sectional view illustrating a rim according to a ninth modified example. (d) of FIG. 4 is a cross-sectional view illustrating a rim according to a tenth modified example. (e) of FIG. 4 is a cross-sectional view illustrating a rim according to an eleventh modified example. (f) of FIG. 4 is a cross-sectional view illustrating a rim according to a twelfth modified example.

FIG. 5 is an exploded perspective view illustrating an electronic percussion instrument according to a second embodiment.

FIG. 6 is a partially enlarged cross-sectional view of the electronic percussion instrument.

FIG. 7 is a partially enlarged cross-sectional view of the electronic percussion instrument.

FIG. 8 is an exploded perspective view illustrating the electronic instrument, a rod and a support.

FIG. 9 (a) of FIG. 9 is a partially enlarged cross-sectional view illustrating a case and taken along a line IXa-IXa of FIG. 7, and (b) of FIG. 9 is a partially enlarged bottom view illustrating the case when viewed in a direction of an arrow IXb in (a) of FIG. 9.

FIG. 10 is an exploded perspective view illustrating an electronic percussion instrument according to a third embodiment.

FIG. 11 is a top view of the electronic percussion instrument.

FIG. 12 is a partially enlarged cross-sectional view illustrating the electronic percussion instrument and taken along a line XII-XII of FIG. 11.

### DESCRIPTION OF EMBODIMENTS

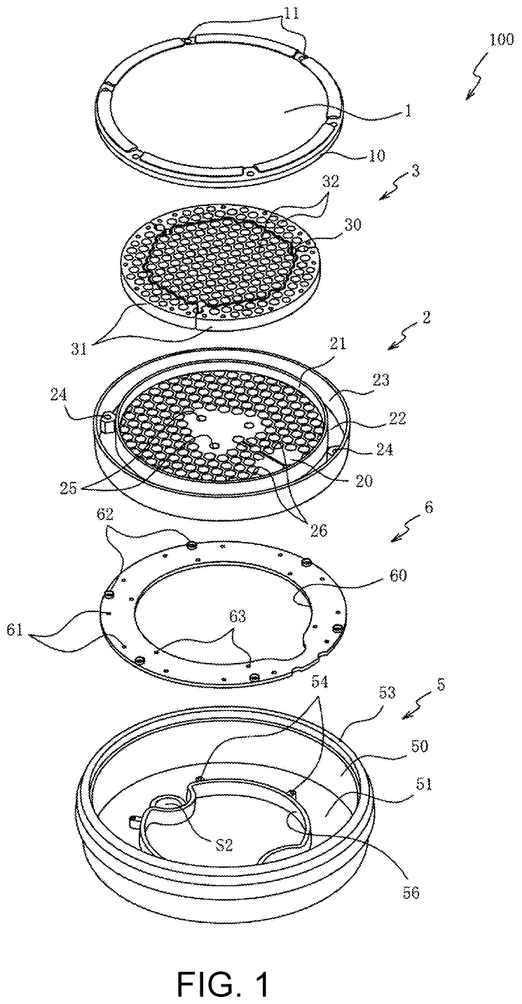

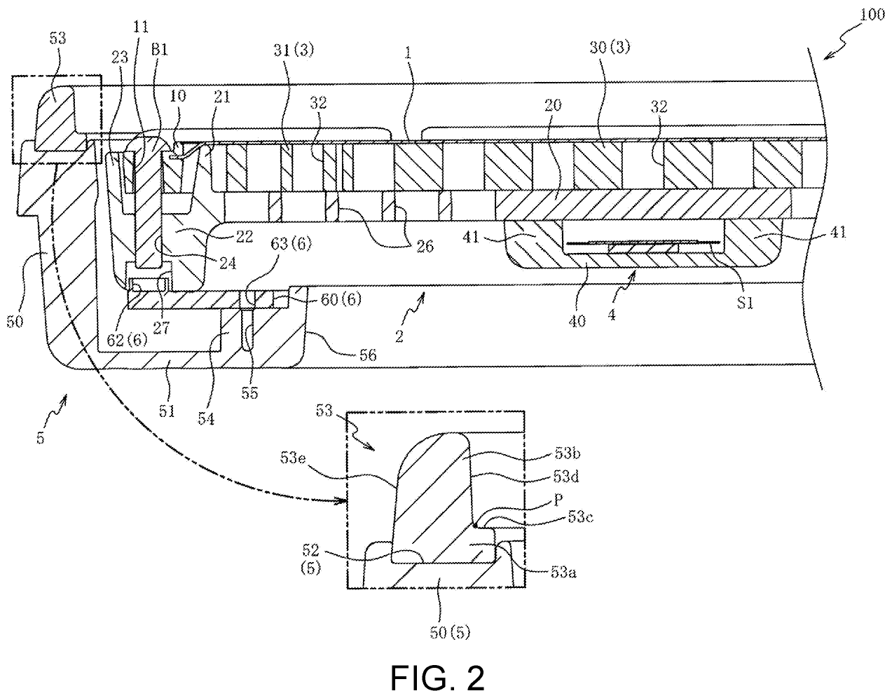

In the following, exemplary embodiments are described with reference to the accompany drawings. Firstly, an electronic percussion instrument 100 according to a first embodiment is described with reference to FIGS. 1 and 2. FIG. 1 is an exploded perspective view illustrating the electronic percussion instrument 100 according to the first embodiment. FIG. 2 is a partially enlarged cross-sectional view of the electronic percussion instrument 100. In FIG. 2, a cross-section taken at a surface along the central axis of a head 1 having a disc shape is shown.

As shown in FIGS. 1 and 2, the electronic percussion instrument 100 is a percussion instrument resembling an acoustic drum. The electronic percussion instrument 100 includes the membrane-like head 1 in which an upper surface forms a percussion surface. The head 1 is formed in a disc shape by using a mesh made of synthetic fibers, and a head frame 10 having an annular shape is fixed to the outer edge of the head 1.

The head frame 10 is formed by using a resin material, and the head 1 and the head frame 10 are integrally formed through mold molding. The head frame 10 may also be formed by using a material (e.g., metal, wood) other than resin, and bonded to the head 1 through adhesion, etc.

The head frame 10 is fixed to a body part 2 of the electronic percussion instrument 100. The body part 2 includes a support part 20 having a disc shape and provided for supporting an elastic body 3 to be described afterwards. A support wall 21 for supporting the head 1 protrudes upward from the outer edge of the support part 20. A bottom wall 22 for fixing the head frame 10 extends toward an outer circumferential side from the lower part of the support wall 21, and an outer circumferential wall 23 protrudes upward from the outer edge of the bottom wall 22. The respective walls 21, 22, 23 are continuous in the circumferential direction, and the head frame 10 is accommodated in a space surrounded by the respective walls 21, 22, 23.

In the embodiment, the support part 20 and the respective walls 21, 22, 23 are integrally formed by using a resin material. However, for example, it may also be configured that the support part 20 formed separately from the respective walls 21, 22, 23 is fixed to the inner circumferential surface of the support wall 21.

Multiple (six in the embodiment) female screw holes 24 are formed equidistantly in the circumferential direction on the bottom wall 22, and multiple insertion holes 11 are formed at positions corresponding to the female screw holes 24 in the head frame 10. In a state in which the head 1 is mounted to the support wall 21, by screwing a bolt B1 (see FIG. 2) inserted into the insertion hole 11 of the head frame 10 into the female screw hole 24, the head frame 10 is pulled downward, and a tension is applied to the head 1. In the following description, a state in which a tension is applied to the head 1 and before the head 1 is percussed is simply referred to and described as “pre-percussion state”.

In the pre-percussion state, the elastic body 3 supported by the support part 20 of the body part 2 contacts the head 1. The elastic body 3 is formed by using an elastic body (e.g., rubber, elastomer, or foamed materials thereof, etc.) having a predetermined flexible property. Therefore, at the time when the performer percusses the head 1 by using a stick, etc., (referred to as “at the time of a percussion to the head 1” in the following), the vibration of the head 1 due to the percussion (impact due to the percussion) is absorbed by the elastic body 3. Accordingly, the percussion sound at the time of the percussion to the head 1 can be reduced.

The elastic body 3 is formed by a central elastic body 30 having a polygonal shape (a hexagonal shape in the embodiment) disposed at the center of the elastic body 3 and multiple peripheral elastic bodies 31 (three in the embodiment) surrounding the periphery of the central elastic body 30. By dividing the elastic body 3 into the central elastic body 30 and the peripheral elastic bodies 31, the sizes of the molds for molding the respective elastic bodies 30. 31 can be reduced.

In the state in which the peripheral elastic bodies 31 are disposed on the periphery of the central elastic body 30, the elastic body 3 is formed in a disc shape as a whole. The diameter of the disc-shaped elastic body 3 is formed to be the same as or slightly smaller than the inner diameter of the support wall 21.

A sensor support member 4 (see FIG. 2) is fixed to the support part 20 supporting the elastic body 3. The sensor support member 4 is formed in a bowl shape and includes a disc-shaped sensor support part 40 to which a head sensor S1 is installed and a wall part 41 protruding upward from the outer edge of the sensor support part 40. Multiple female screw holes (not shown) arranged in the circumferential direction of the wall part 41 are formed on the upper surface of the wall part 41, and multiple insertion holes 25 (see FIG. 1) facing the female screw holes of the wall part 41 in the upper-lower direction are formed in the support part 20 of the body part 2. By screwing bolts (not shown) inserted into the insertion holes 25 into the female screw holes of the wall part 41, the sensor support member 4 is fixed to the lower surface of the support part 20.

The head sensor S1 is a disc-shaped piezoelectric element and is bonded to the upper surface of the sensor support part 40 by using a double-sided tape having a cushion property. The vibration at the time of the percussion to the head 1 is propagated to the head sensor S1 via the elastic body 3, the support part 20 of the body part 2, and the sensor support member 4.

Multiple through holes 32 connecting the upper surface and the lower surface of the elastic body 3 in the upper-lower direction are formed in the elastic body 3 (the central elastic body 30 and the peripheral elastic bodies 31). Therefore, compared with the case where the through holes 32 are not formed, the sound produced due to the vibration of the elastic body 3 at the time of the percussion to the head 1 can be effectively reduced. Meanwhile, in regions where the through holes 32 are not formed, the vibration at the time of the percussion to the head 1 is propagated to the support part 20 via the elastic body 3 itself. Accordingly, the vibration at the time of the percussion to the head 1 can be propagated to the head sensor S1 via the support part 20. Accordingly, the percussion to the head 1 can be accurately detected, while the percussion sound at the time of the percussion to the head 1 can be reduced.

In the embodiment, the honeycomb-shaped through hole 32 (in a hexagonal cross-sectional shape) extends linearly in the upper-lower direction, and the cross-sectional area (inner diameter) of the through hole 32 is constant from the upper end to the lower end. However, the invention is not limited thereto. For example, the through hole 32 may also have a linear shape inclined with respect to the thickness direction (upper-lower direction) of the elastic body 3, and the through hole 32 may also be formed in a shape combining a straight line and a curved line (e.g., a spiral shape or a meandering shape) from the upper end to the lower end. The cross-sectional shape of the through hole 32 may also be circular or other polygonal shape, and it may also be configured that the cross-sectional area (inner diameter) of the through hole 32 changes in a portion of or the entirety of the region of the through hole 32 from the upper end to the lower end.

The vibration propagated to the support part 20 at the time of the percussion to the head 1 is not limited to those propagated via the through holes 32, but also the vibration propagated through the elastic body 3 itself (portions where the through holes 32 are not formed). Accordingly, for example, if the elastic body 3 is hard, it is easy for the vibration at the time of the percussion to the head 1 to be propagated to the support part 20, but if the elastic body 3 is excessively hard, it becomes difficult to absorb the vibration at the time of the percussion to the head 1. Also, if the elastic body 3 is soft, it is easy to absorb the vibration at the time of the percussion to the head 1, but if the elastic body 3 is excessively soft, it becomes easy for the vibration at the time of the percussion to be propagated to the head 1.

Accordingly, in the case where the elastic body 3 is formed of an elastic material (a solid material that is not a foamed material) such as rubber or elastomer, an elastic material that conforms to JIS K6253-3:2012 and exhibits a hardness of 10 or more and 50 or less as measured with a durometer type A hardness tester may be used.

In addition, in the case where the elastic body 3 is formed of a foamed material (sponge) such as rubber or synthetic resin, a foamed material that conforms to JIS K6253-3:2012 and exhibits a hardness of 20 or more and 75 or less as measured with a durometer type E hardness tester may be used.

By forming the elastic body 3 by using an elastic material or a foamed material exhibiting such hardness, the vibration at the time of the percussion to the head 1 can be appropriately propagated to the support part 20 (the head sensor S1) via the elastic body 3, while the the vibration at the time of the percussion to the head 1 can be appropriately absorbed by the elastic body 3. Accordingly, the percussion to the head 1 can be accurately detected, while the percussion sound at the time of the percussion to the head 1 can be reduced.

Here, the head 1 may be formed by using a film made of a synthetic resin. However, in the embodiment, the head 1 is formed by using an air-permeable material (a mesh having multiple through holes). In addition, the support part 20 is also formed with multiple through holes 26. This is to effectively reduce the percussion sound at the time of the percussion to the head 1.

That is, for example, when the head 1 is formed by a film made of synthetic resin and does not exhibits an air-permeable property, it is difficult to reduce the percussion sound at the time of the percussion to the head 1 (the sound produced by the head 1 itself. Meanwhile, when it is configured that the plate-shaped support part 20 does not include the through holes 26, even if the head 1 is air-permeable, the support part 20 (body part 2) resonates with the vibration at the time of the percussion to the head 1, and it is difficult to reduce the percussion sound at the time of the percussion to the head 1.

Comparatively, in the embodiment, since the head 1 is air-permeable and the support part 20 is formed with multiple through holes 26, the flow path of the air passing through the head 1, the elastic body 3, and the support part 20 can be secured. Accordingly, at the time of the percussion to the head 1, the sound produced due to the vibration of the head 1 itself and the sound produced due to the resonance with other components, such as the support part 20, can be reduced.

In addition, in the pre-percussion state, the elastic body 3 is in contact with the head 1. Accordingly, since the vibration at the time of the percussion to the head 1 is easily absorbed by the elastic body 3, the percussion sound at the time of the percussion can be effectively reduced. Moreover, with the elastic body 3 in contact with the head 1 in the pre-percussion state, a feeling of percussion close to that of an acoustic drum can be attained.

Although the through holes 26 of the support part 20 are formed throughout substantially the entirety of the support part 20, the through holes 26 are not formed in the support part 20 in a region facing the sensor support part 40. Accordingly, a foreign matter, such as dust, can be suppressed from entering the inside of the sensor support member 4 via the through holes 26.

In the following, the configuration of an outer frame member 5 supporting the body part 2 of the electronic percussion instrument 100 is described. The outer frame member 5 includes an outer circumferential part 50 having a cylindrical shape and disposed on the outer circumferential side of the body part 2, and a bottom part 51 projecting from the lower end of the outer circumferential part 50 toward the inner circumferential side. The respective components 50, 51 are integrally formed by using a resin material.

A concave part 52 (see the enlarged portion of FIG. 2) having a groove shape continuous in the circumferential direction is formed on the upper surface of the outer circumferential part 50, and a rim 53 having an annular shape is fixed to the concave part 52. The rim 53 includes a base part 53a fit into the concave part 52 and a main body part 53b whose radial dimension is smaller than the base part 53a, and the respective parts 53a, 53b are integrally formed by using rubber.

The upper end of the main body part 53b is located higher than the head 1 (head frame 10), and by percussing the main body part 53b, the performance resembling a rim shot is performed. The percussion to the rim 53 (the main body part 53b) is detected by a rim sensor S2 (see FIG. 1). The rim sensor S2 is a piezoelectric element having a disc shape, and is bonded to the upper surface of the bottom part 51 of the outer frame member 5 by using a double-sided tape having a cushion property.

When the rim 53 (the main body part 53b) is percussed, the vibration propagated via the outer circumferential part 50 and the bottom part 51 of the outer frame member 5 is detected by the rim sensor S2. In addition, as described above, the vibration at the time of the percussion to the head 1 is detected by the head sensor S1 (see FIG. 2). The percussions detected by the sensors S1, S2 are converted into electrical signals and output to a sound source device not shown herein. Accordingly, a musical sound in accordance with a percussion position to the electronic percussion instrument 100 is produced.

In such case, when the vibration at the time of the percussion to the head 1 is detected by the rim sensor S2, or the vibration at the time of the percussion to the rim 53 is detected by the head sensor S1, the respective percussions cannot be determined accurately. Therefore, in the embodiment, an elastic body 6 made of rubber is interposed between the body part 2 and the outer frame member 5.

The elastic body 6 is formed in a disc shape (annular shape) having a through hole 60 at the center. Multiple insertion holes 61 (see FIG. 1) arranged in the circumferential direction are formed on the outer edge side of the elastic body 6. By screwing bolts (not shown) inserted into the insertion holes 61 into the female screw holes (not shown) of the bottom wall 22 of the body part 2, the elastic body 6 is fixed to the body part 2.

In addition, multiple cylindrical parts 62 having a cylindrical shape and arranged in the circumferential direction are formed on the outer edge side of the elastic body 6, and multiple positioning concave parts 27 (see FIG. 2) facing the cylindrical parts 62 in the upper-lower direction are formed on the bottom surface of the bottom wall 22 of the body part 2. Accordingly, by fitting the cylindrical parts 62 into the positioning concave parts 27, the elastic body 6 can be screw-fastened to the body part 2 in a state in which the elastic body 6 is positioned with respect to the body part 2 in the circumferential direction.

Multiple insertion holes 63 arranged in the circumferential direction are formed on the inner edge side of the elastic body 6, and multiple convex parts 54 at positions corresponding to the insertion holes 63 are formed on the upper surface of the bottom part 51 of the outer frame member 5. Female screw holes 55 (see FIG. 2) are formed in the convex parts 54. By screwing bolts (not shown) inserted into the insertion holes 63 of the elastic body 6 into the female screw holes 55, the elastic body 6 is fixed to the outer frame member 5.

The insertion holes 63 of the elastic body 6 (the female screw holes 55 of the outer frame member 5) face the through holes 26 of the support part 20 in the upper-lower direction. Accordingly, by using a tool (a driver, etc.) passing through the through hole 26 of the support part 20, the bolt can be easily screwed into the female screw hole 55.

In this way, with the elastic body 6 made of rubber being interposed between the body part 2 and the outer frame member 5, the vibration at the time of the percussion to the head 1 or the rim 53 can be absorbed (attenuated) by the elastic body 6. That is, since the vibration at the time of the percussion to the head 1 can be suppressed from being detected by the rim sensor S2, or the vibration at the time of the percussion to the rim 53 can be suppressed from being detected by the head sensor S1, whether any of the head 1 and the rim 53 is percussed can be accurately determined.

Also, in the embodiment, the outer frame member 5 (the bottom part 51) is screw-fastened to the inner edge side of the elastic body 6, and the body part 2 (the bottom wall 22) is screw-fastened to the outer edge side of the elastic body 6. That is, the support position of the elastic body 6 by the outer frame member 5 is located on the inner circumferential side with respect to the support position of the body part 2 by the elastic body 6. In addition, since the elastic body 6 is supported by the convex part 54 formed on the bottom part 51 of the outer frame member 5, a space allowing a downward displacement of the elastic body 6 (the body part 2) is formed on the outer circumferential side of the convex part 54. Accordingly, at the time when the head 1 is percussed, the body part 2 is displaced to sink into the side of the bottom part 51 of the outer frame member 5 due to the elastic deformation of the elastic body 6, so the impact at the time of the percussion to the head 1 can be absorbed through the displacement of the body part 2.

In addition, the through hole 60 is formed at the center of the elastic body 6, and a through hole 56 is also formed on the inner circumferential side of the bottom part 51 of the outer frame member 5. That is, in the embodiment, with the air-permeable head 1, the through holes 32 of the elastic body 3, the through holes 26 of the body part 2 (the support part 20), the through hole 60 of the elastic body 6, and the through hole 56 of the outer frame member 5 (the bottom part 51), the air flow path from the head 1 to the bottom part 51 of the outer frame member 5 is secured. Accordingly, the percussion sound at the time of the percussion to the head 1 can be effectively reduced.

In the following, the detailed configuration of the rim 53 is described. As shown in the enlarged portion of FIG. 2, the base part 53a of the rim 53 is fit into the concave part 52 of the outer frame member 5 (the outer circumferential part 50), but the base part 53a is bonded to the concave part 52 throughout the entire circumference by using an adhesive or a double-sided tape. Accordingly, when the rim 53 is percussed, the fluttering of the rim 53 with respect to the outer frame member 5 can be suppressed.

In addition, the base part 53a of the rim 53 protrudes from the lower end of the main body part 53b toward the inner circumferential side, and a curved portion P is formed on the inner circumferential surface of the rim 53 by using an upper surface 53c of the base part 53a extending in the radial direction and an inner circumferential surface 53d of the main body part 53b extending upward from the outer edge of the upper surface 53c. Meanwhile, an outer circumferential surface 53e of the rim 53 formed by using the base part 53a and the main body part 53b is a curved surface that is inclined downward toward the outer circumferential side from the upper end thereof to the lower end. With such shape of the rim 53, when the rim 53 (the main body part 53b) is percussed from the outer circumferential side, the rim 53 is easily deformed toward the inner circumferential side (right side of FIG. 2) with the curved portion P of the inner circumferential surface of the rim 53 as the starting point. With such deformation, the impact at the time of the percussion to the rim 53 can be absorbed. Therefore, the percussion sound due to such percussion can be reduced.

In addition, the rim 53 is formed by using an elastic material that conforms to JIS K6253-3:2012 and exhibits a hardness of 10 or more and 50 or less as measured with a durometer type A hardness tester. With the rim 53 being formed of such soft elastic material, the percussion sound when the rim 53 is percussed can be effectively reduced.

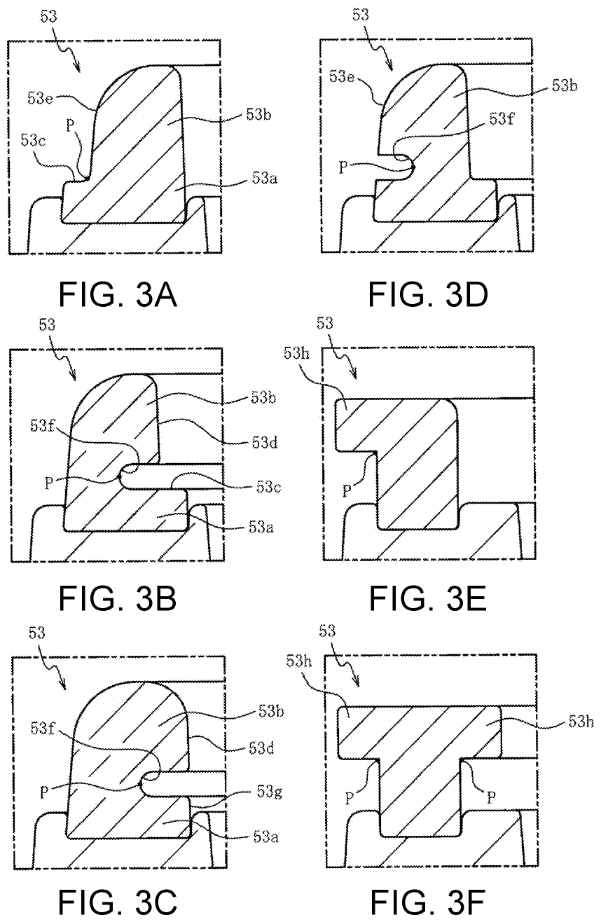

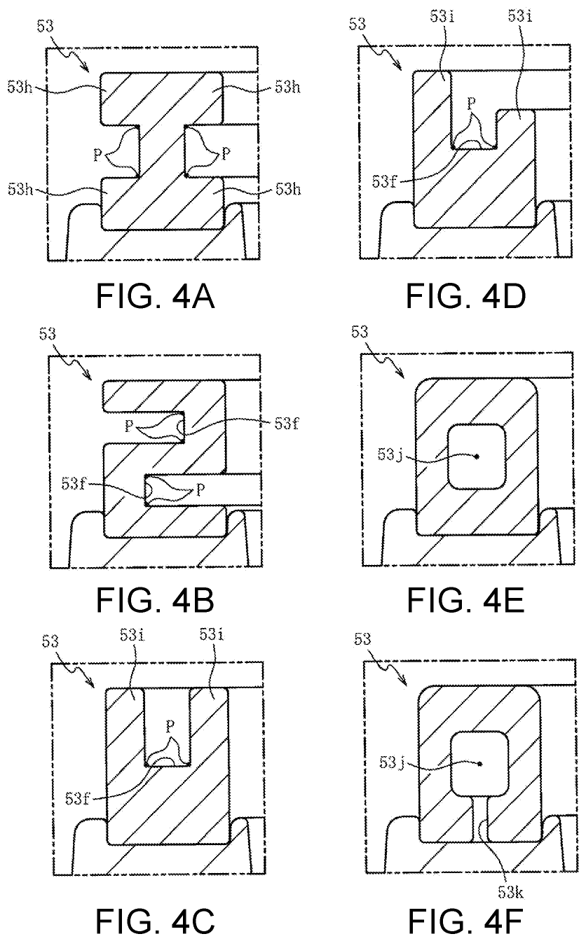

In the following, modified examples of the rim 3 are described with reference to (a) to (f) of FIG. 3 and (a) to (f) of FIG. 4. Parts same as those of the rim 53 described above are described by assigning the same reference numerals. (a) to (f) of FIG. 3 are cross-sectional views of the rim 53 showing first to sixth modified examples, and (a) to (f) of FIG. 4 are cross-sectional views of the rim 53 showing seventh to twelfth modified examples.

As shown in (a) of FIG. 3, in the rim 53 of the first modified example, the base part 53a protrudes toward the outer circumferential side from the lower end of the main body part 53b, and on the outer circumferential surface of the rim 53, the curved portion P is formed by using the upper surface 53c of the base part 53a extending in the radial direction and the outer circumferential surface 53e of the rim 53 (the main body part 53b) extending upward from the inner edge of the upper surface 53c. Accordingly, in the case where the rim 53 is percussed (referred to as “at the time of percussion” in the following), the rim 53 is easily deformed with the curved portion P as the starting point.

As shown in (b) of FIG. 3, in the rim 53 of the second modified example, a concave part 53f is formed at a border portion between the upper surface 53c of the base part 53a and the inner circumferential surface 53d of the main body part 53b. The concave part 53f is formed in an annular shape continuous throughout the entire circumference of the rim 53. Accordingly. since the curved portion P is formed on the inner circumferential surface of the rim 53 (a deeper portion of the concave part 53f), at the time of percussion, the rim 53 is easily deformed with the curved portion P as the starting point.

As shown in (c) of FIG. 3, the rim 53 of the third modified example is a rim in which, in the rim 53 of the second modified example (see (b) of FIG. 3), an inner circumferential surface 53g of the base part 53a is flush with the inner circumferential surface 53d of the main body part 53b. That is, in the rim 53 of this modified example, the radial dimension of the base part 53a and the radial dimension of the lower end of the main body part 53b (a region where the concave part 53f is not formed) are substantially the same. In this modified example as well, at the time of percussion, the rim 53 is easily deformed with the curved portion P as the starting point.

As shown in (d) of FIG. 3, the rim 53 of the fourth modified example is a rim in which, in the rim 53 of the second modified example (see (b) of FIG. 3), the concave part 53f is formed on the lower end side of the outer circumferential surface 53e of the main body part 53b, instead of the inner circumferential surface of the rim 53. Accordingly, at the time of percussion, the rim 53 is easily deformed with the curved portion P as the starting point. Also, like the fourth modified example, it is also possible to form the concave part 53 on the outer circumferential surface of the rim 53 in the rim 53 of the third modified example (see (c) of FIG. 3).

As shown in (e) of FIG. 3, in the rim 53 of the fifth modified example, an L shape is formed, in which a convex part 53h protrudes from the upper end side of the outer circumferential surface thereof. Accordingly, since the curved portion P is formed on the outer circumferential surface of the rim 53, at the time of percussion, the rim 53 (the convex part 53h) is easily deformed with the curved portion P as the starting point.

As shown in (f) of FIG. 3, the rim 53 of the sixth modified example is a rim in which, in the rim 53 of the fifth modified example (see (e) of FIG. 3), the convex part 53h also protrudes from the upper end side of the inner circumferential surface of the rim 53 to form a T shape. Accordingly, since the curved portion P is formed on the outer circumferential surface and the inner circumferential surface of the rim 53, at the time of percussion, the rim 53 (the convex part 53h) is easily deformed with the curved portion P as the starting point.

As shown in (a) of FIG. 4, the rim 53 of the seventh modified example is a rim in which, in the rim 53 of the sixth modified example (see (f) of FIG. 3), the convex part 53h also protrudes from the lower end side of the inner circumferential surface and the outer circumferential surface of the rim 53 to form an H shape. Accordingly, since the curved portion P is formed on the outer circumferential surface and the inner circumferential surface of the rim 53, at the time of percussion, the rim 53 (the convex part 53h) is easily deformed with the curved portion P as the starting point.

As shown in (b) of FIG. 4, in the rim 53 of the eighth modified example, a pair of concave parts 53f are formed on the lower end side (lower side with respect to the center in the upper-lower direction) of the inner circumferential surface thereof and the upper end side (upper side with respect to the center of the upper-lower direction) of the outer circumferential surface thereof. That is, the concave part 53f on the inner circumferential side of the rim 53 and the concave part 53f on the outer circumferential side of the rim 53 are formed in different heights. Accordingly, since the curved portion P is formed on the inner circumferential surface and the outer circumferential surface of the rim 53, at the time of percussion, the rim 53 is easily deformed with the curved portion P as the starting point.

As shown in (c) of FIG. 4, in the rim 53 of the ninth modified example, the concave part 53f is formed on the upper surface thereof. The concave part 53f is formed in the radial central portion of the upper surface of the rim 53, and a pair of convex parts 53i sandwiching the concave part 53f are formed on the upper surface of the rim 53. Accordingly, since the curved portion P is formed on the upper surface of the rim 53 (a deeper portion of the concave part 53). at the time of percussion, the rim 53 (the convex part 53i) is easily deformed with the curved portion P as the starting point.

In the rim 53 of the modified example shown in (c) of FIG. 4, the height of the convex part 53i on the inner circumferential side and the height of the convex part 53i on the outer circumferential side are the same. However, in the rim 53 of the tenth modified example shown in (d) of FIG. 4, the convex part 53i on the outer circumferential side is higher than the convex part 53i on the inner circumferential side. That is, the heights of the convex parts 53i on the inner circumferential side and the outer circumferential side are different. In the modified example as well, since the curved portion P is formed on the upper surface of the rim 53 (a deeper portion of the concave part 53), at the time of percussion, the rim 53 (the convex part 53i) is easily deformed with the curved portion P as the starting point.

As shown in (e) of FIG. 4, the rim 53 of the eleventh modified example is a rim formed in a hollow shape having a cavity 53j inside. The cavity 53f is formed continuously in the circumferential direction. Accordingly, at the time of percussion, the rim 53 is easily deformed toward the side of the cavity 53j (the deformation of the rim 53 can be received by the cavity 53j).

As shown in (f) of FIG. 4, the rim 53 of the twelfth modified example is a rim in which, in the rim 53 of the eleventh modified example (see (e) of FIG. 4), a slit 53k connected with the cavity 53j is formed on the lower surface of the rim 53. The slit 53k is formed continuously in the circumferential direction. Accordingly, at the time of percussion, the rim 53 is easily deformed toward the side of the cavity 53j. Although the slit 53k is formed on the lower surface of the rim 53 in (f) of FIG. 4, the slit 53k may also be formed on the inner circumferential surface, the outer circumferential surface, or the upper surface of the rim 53.

In the configurations of the respective modified examples shown in (a) to (f) of FIG. 3 and (a) to (f) of FIG. 4, the impact at the time of percussion can also be absorbed through the deformation of the rim 53, so the percussion sound produced at the time of percussion can be reduced.

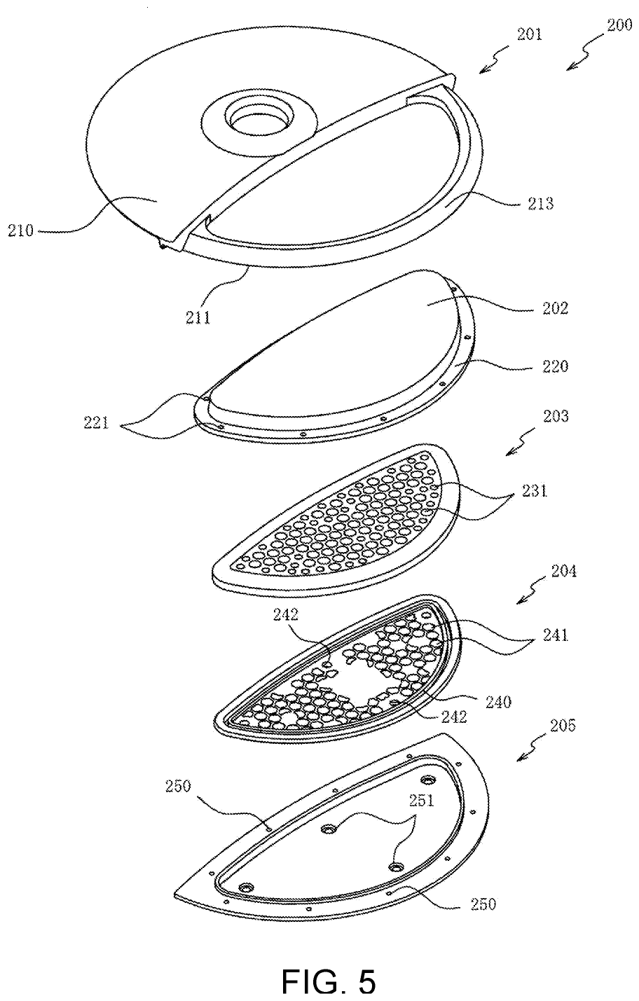

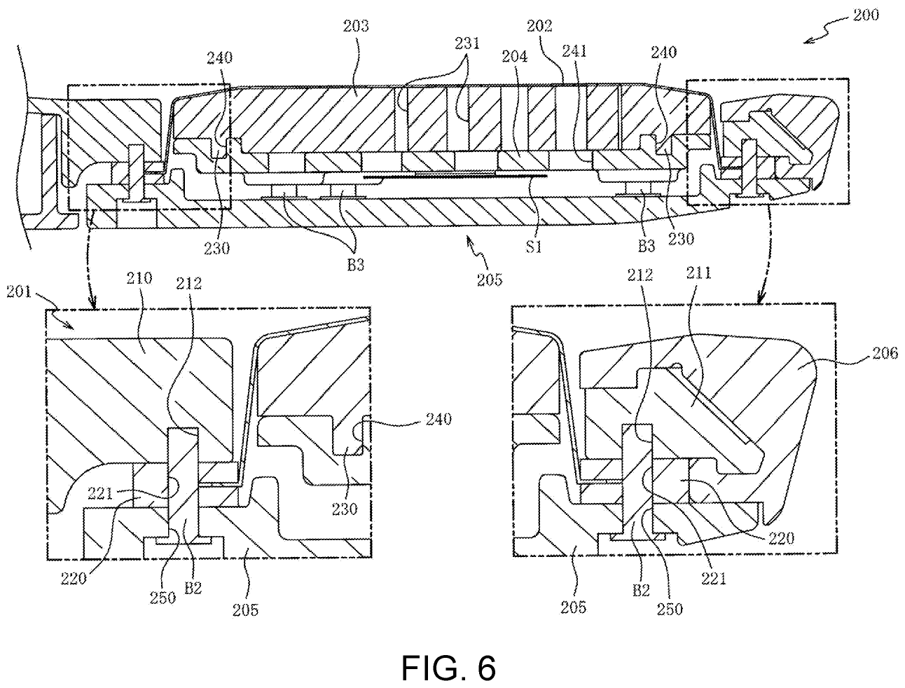

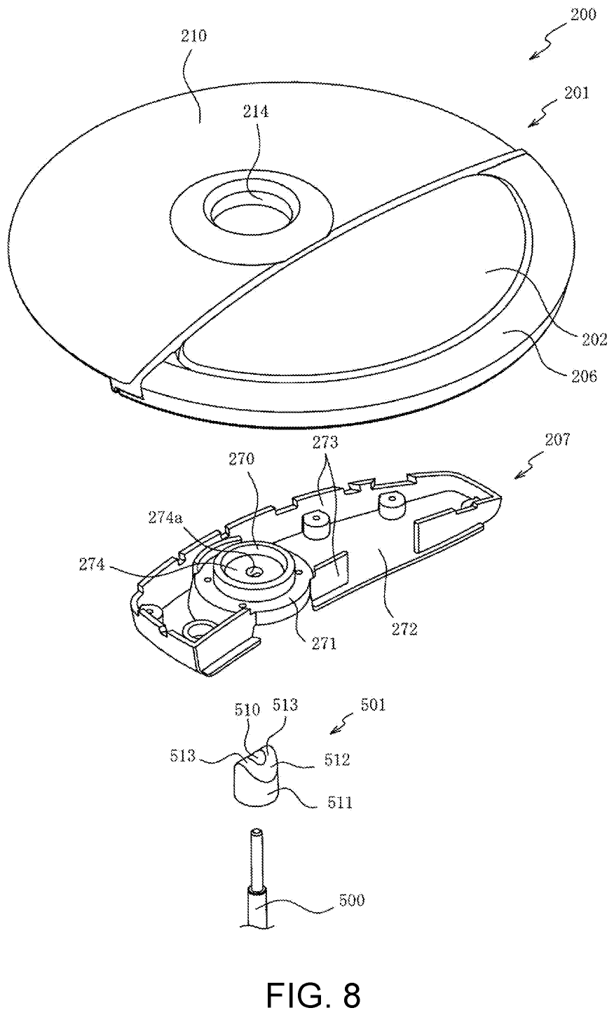

In the following, an overall configuration of an electronic percussion instrument 200 according to a second embodiment is described with reference to FIG. 5. FIG. 5 is an exploded perspective view illustrating the electronic percussion instrument 200 according to the second embodiment. In FIG. 5, a state in which a cover 206 (see FIG. 6 or 8) to be described afterwards is removed from a main body frame 201 is shown.

As shown in FIG. 5, the electronic percussion instrument 200 of the second embodiment is a percussion instrument resembling an acoustic cymbal. The skeleton of the electronic percussion instrument 200 is formed by the main body frame 201. The main body frame 201 includes an upper surface part 210 forming the upper surface of the electronic percussion instrument 200. An arced part 211 in an arced shape is connected with a portion formed in a linear shape in the flat, semicircular upper surface part 210.

The upper surface part 210 and the arced part 211 are integrally formed by using a resin material, and the outer edge of the main body frame 201 is formed in a circular shape as a whole by using the respective parts 210, 211. An opening portion in a semicircular shape surrounded by the upper surface part 210 and the arced part 211 is a space for accommodating the head 202.

A head frame 220 is connected with the outer edge of the head 202, and except for being semicircular, the head 202 and the head frame 220 have the same configuration as the head 1 and the head frame 10 of the first embodiment. Also, like the head 202 and the head frame 220, the respective components of an elastic body 203, a support frame 204, and a base frame 205 are also formed in a semicircular shape (i.e., having a linear portion and an arced portion). Accordingly, in the following description, the edge parts along the linear portion or the arced portion of each semicircular component is referred to as “the linear part of the head frame 220”, “the arced part of the base frame 205”, etc.

Each of the linear part and the arced part of the head frame 220 is formed with multiple insertion holes 221. The insertion hole 221 is a hole for fastening the head frame 220 as well as the base frame 205 to the upper surface part 210 and the arced part 211 of the main body frame 201 by using a bolt B2 (see FIG. 6).

The fixing structure of the head frame 220 and the base frame 205 is described with reference to FIGS. 5 and 6. FIG. 6 is a partially enlarged cross-sectional view of the electronic percussion instrument 200. FIG. 6 illustrates a cross-section taken at a surface including insertion holes 250 (insertion holes 250 formed in the linear part and the arced part of the base frame 205) labeled with the symbol 250 in FIG. 5. In addition, FIG. 6 mainly illustrates only a cross-sectional surface (end surface) of the electronic percussion instrument 200, in addition to a portion of the internal structure (e.g., bolts B3).

As shown in FIGS. 5 and 6, the base frame 205 is formed in a flat, semicircular shape by using resin, and, in the linear part and the arced part of the base frame 205, multiple insertion holes 250 facing the insertion holes 221 of the head frame 220 in the upper-lower direction are formed.

On the lower surface of each of the upper surface part 210 and the arced part 211 of the main body frame 201, multiple female screw holes 212 (see the enlarged portion of FIG. 6) are formed. By screwing the bolts B2 inserted into the insertion holes 221, 250 of the head frame 220 and the base frame 205, respectively, into the female screw holes 212, the head frame 220 and the base frame 205 are fixed to the lower surface of the main body frame 201.

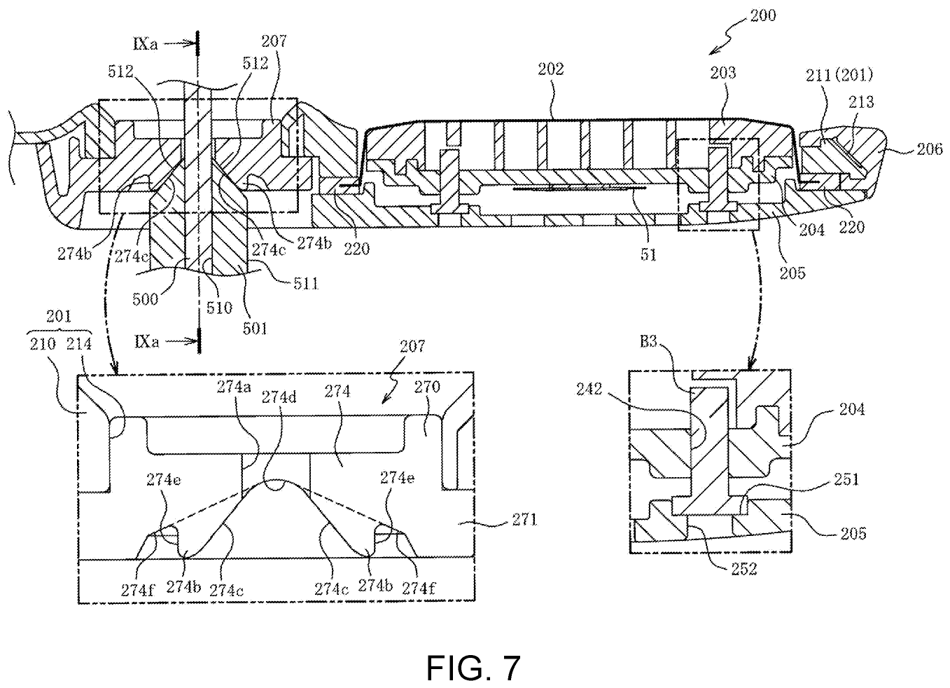

The support frame 204 and the elastic body 203 supported by the support frame 204 are accommodated in the space between the head 202 and the base frame 205. The support frame 204 is supported by the base frame 205 via the bolts B3 (see FIG. 6). The support structure will be described afterwards with reference to FIG. 7.

The support frame 204 is formed in a flat, semicircular shape by using resin. On the upper surfaces of the linear part and the arced part of the support frame 204, a groove-shaped positioning concave part 240 for positioning the elastic body 203 is formed.

On the lower surfaces of the linear part and the arced part of the elastic body 203, a positioning convex part 230 (see FIG. 6) having a shape corresponding to the positioning concave part 240 is formed. In the state in which the positioning convex part 230 of the elastic body 203 is fit into the positioning concave part 240, the elastic body 203 may be bonded to the support frame 204, and the elastic body 203 may also be simply mounted to the support frame 204 (without bonding).

The elastic body 203 is formed by using an elastic body (e.g., rubber, elastomer, or foamed materials thereof, etc.) having a predetermined flexible property. Therefore, at the time when the performer percusses the head 202 by using a stick, etc., (referred to as “at the time of a percussion to the head 202” in the following), the vibration of the head 202 due to the percussion is absorbed by the elastic body 203. Accordingly, the percussion sound at the time of the percussion to the head 202 can be reduced.

The vibration at the time of the percussion to the head 202 is detected by the head sensor S1 (see FIG. 6). The head sensor S1 is a disc-shaped piezoelectric element and is bonded to the lower surface of the support frame 204 by using a double-sided tape having a cushion property. The vibration at the time of the percussion to the head 202 is propagated to the head sensor S1 via the elastic body 203 and the support frame 204.

Multiple through holes 231 connecting the upper surface and the lower surface of the elastic body 203 are formed in the elastic body 203. Therefore, compared with the case where the through holes 231 are not formed, the sound produced due to the vibration of the elastic body 203 at the time of the percussion to the head 202 can be effectively reduced. Meanwhile, in regions where the through holes 231 are not formed, the vibration at the time of the percussion to the head 202 is propagated to the support frame 204 via the elastic body 203 itself. Accordingly, the percussion to the head 202 can be accurately detected, while the percussion sound at the time of the percussion to the head 202 can be reduced.

In the embodiment, the through hole 231 having a circular cross-sectional shape extends linearly in the upper-lower direction, and the cross-sectional area (inner diameter) of the through hole 231 is constant from the upper end to the lower end. However, the invention is not limited thereto. For example, the through hole 231 may also have a linear shape inclined with respect to the thickness direction (upper-lower direction) of the elastic body 203, and the through hole 231 may also be formed in a shape combining a straight line and a curved line (e.g.,

a spiral shape or a meandering shape) from the upper end to the lower end. In addition, the cross-sectional shape of the through hole 231 may also be a honeycomb shape (hexagonal cross-sectional shape) or other polygonal shapes, and it may also be configured that the cross-sectional area (inner diameter) of the through hole 231 changes in a portion of or the entirety of the region of the through hole 231 from the upper end to the lower end.

In the case where the elastic body 203 is formed of an elastic material (a solid material that is not a foamed material) such as rubber or elastomer, an elastic material that conforms to JIS K6253-3:2012 and exhibits a hardness of 10 or more and 50 or less as measured with a durometer type A hardness tester may be used. In addition, in the case where the elastic body 203 is formed of a foamed material (sponge) such as rubber or synthetic resin, a foamed material that conforms to JIS K6253-3:2012 and exhibits a hardness of 20 or more and 75 or less as measured with a durometer type E hardness tester may be used. Accordingly, like the first embodiment, the percussion to the head 202 can be accurately detected, while the percussion sound at the time of the percussion to the head 202 can be reduced.

In addition, the head 202 is air-permeable, and multiple through holes 241 connecting the upper surface and the lower surface of the support frame 204 are formed on the support frame 204. In addition, multiple through holes (see FIG. 7) are also formed in a region of the base frame 205 facing the support frame 204. That is, in the electronic percussion instrument 200, a flow path of air passing through the head 202, the elastic body 203, the support frame 204, and the base frame 205 is secured. Accordingly, at the time of the percussion to the head 202, the sound produced due to the vibration of the head 202 itself or the sound produced due to the resonance of other components, such as the support part 204 and the base frame 205, can be reduced.

In addition, in the pre-percussion state, the elastic body 203 is in contact with the head 202. Accordingly, since the vibration at the time of the percussion to the head 202 is easily absorbed by the elastic body 203, the percussion sound at the time of the percussion can be effectively reduced.

Here, for example, as disclosed in Japanese Laid-open No. 2019-148623, in a conventional electronic percussion instrument in which a percussion surface is formed by the head, it is common to apply a tension to the head by pressing the head frame to the body side of the percussion instrument by using a hoop.

In the case of the configuration of the conventional art, it is required to provide a hoop or a tension bolt for pressing the hoop to the body side on the outer circumferential side with respect to the head (head frame), and an issue that the size of the electronic percussion instrument increases in the radial direction arises. In addition, since it is necessary to secure a space for displacing the hoop (head frame) in the upper-lower direction, the outer edge (edge) portion of the electronic percussion instrument cannot be formed thin. As a result, an issue that it is difficult to form the electronic percussion instrument in a flat shape like a cymbal arises.

Comparatively, the electronic percussion instrument 200 of the embodiment provides a configuration capable of addressing the issue. The configuration is described with reference to FIGS. 5 and 7. FIG. 7 is a partially enlarged cross-sectional view of the electronic percussion instrument 200. In FIG. 7, a cross-section taken at a surface including insertion holes 251 labeled with the symbol 251 of FIG. 5 is shown. In addition, FIG. 7 mainly illustrates only a cross-sectional surface (end surface) of the electronic percussion instrument 200, in addition to a portion of the internal structure (e.g., a case 207).

As shown in FIGS. 5 and 7, the insertion holes 251 for rotatably inserting the heads of the bolts B3 are formed on the upper surface of the base frame 205. The insertion holes 251 are formed at three places (see FIG. 5) along the linear part of the base frame 205 and one place in the central portion of the arced part.

The insertion hole 251 is a circular hole having an inner diameter same as (or slightly greater than) the diameter of the head of the bolt B3. A through hole 252 is formed on the bottom surface of the insertion hole 251 (see the enlarged portion on the right side of FIG. 7), and it is possible to rotate the bolt B3 by using a tool (e.g., a driver) inserted from the through hole 252.

Female screw holes 242 are formed in the support frame 204 at positions facing the insertion holes 251 of the base frame 205 in the upper-lower direction. Accordingly, by turning the bolt B3 in a pull-out (loosening) direction from the female screw hole 242 in the state in which the bolt B3 screwed into the female screw hole 242 from below is inserted into (mounted in) the insertion hole 251 of the base frame 205, the support frame 204 can be displaced upward with respect to the base frame 205. Meanwhile, by turning the bolt B3 in a direction of screwing the bolt B3 into the female screw hole 242, the support frame 204 can be displaced downward. That is, by adjusting the screwing amount of the bolts B3, the support frame 204 can be relatively displaced with respect to the base frame 205 in the upper-lower direction.

In this way, the embodiment is provided with the head frame 220 connected with the outer edge of the head 202, the base frame 205 to which the head frame 220 is fixed, the support frame 204 disposed above the base frame 205, and the bolts B3 for relatively displacing the support frame 204 with respect to the base frame 205 in the upper-lower direction, and the elastic body 203 is supported by the support frame 204.

Accordingly, by displacing the support frame 204 upward with respect to the base frame 205 through the rotation of the bolts B3 and pushing the head 202 upward by using the elastic body 203, a tension can be applied to the head 202. Accordingly, it is not required to dispose a hoop or a tension bolt for pressing the hoop to the body side on the outer circumferential side with respect to the head 202 (the head frame 220) as in the conventional art. Accordingly, the size of the electronic percussion instrument 200 can be reduced in the radial direction. In addition, since it is not necessary to secure the space for displacing the hoop (head frame 220) in the upper-lower direction, the outer edge (edge) portion of the electronic percussion instrument 200 can be formed thin. Accordingly, the electronic percussion instrument 200 can be formed in a flat shape like a cymbal.

Here, the percussion to the head 202 resembling the bow of a cymbal is detected by the head sensor S1 as described above. Meanwhile, the percussion to the arced part 211 of the main body frame 201 resembling the edge portion of the bow is detected by an edge sensor (not shown) installed to a sensor installation surface 213 of the arced part 211.

The sensor installation surface 213 is inclined downward toward the outer circumferential side of the arced part 211, and the edge sensor is bonded to the sensor installation surface 213. The edge sensor is a sheet-like pressure sensor (e.g., membrane switch).

Although the upper surface and the lower surface of the arced part 211 including the sensor installation surface 213 are covered by the cover 206 (see FIG. 7) made of rubber, a space is formed between the sensor installation surface 213 (edge sensor) and the cover 206. Accordingly, when the performer percusses the cover 206 by using a stick, etc., the edge sensor is pressed through the elastic deformation of the cover 206. Accordingly, the percussion to the cover 206 (the arced part 211) can be detected by the edge sensor.

In addition, the edge sensor is provided with a function of detecting a choke technique in which the performer grabs the arced part 211, in addition to the function of detecting the percussion to the cover 206. Regarding the process for determining the percussion to the cover 206 and the choke technique, a conventional process can be adopted, so details in this regard are omitted. As a conventional process, for example, a process disclosed in para. [0005] to [0008], etc., of Japanese Laid-open No. H06-035450 is exemplified.

The percussions detected by the edge sensor or the head sensor S1 are converted into electrical signals and output to a sound source device not shown herein. Accordingly, a musical sound in accordance with a percussion position to the electronic percussion instrument 200 is produced. Such performance of the electronic percussion instrument 200 is carried out in a state in which the electronic percussion instrument 200 is supported by a rod 500.

As a conventional technique of the support structure of the electronic percussion instrument with respect to the rod 500, for example. International Publication No. 2022/044171 is exemplified. In the conventional art, the electronic percussion instrument 1 is supported by a rod 2 by hooking a support 20 to a through hole 30 of a support rubber 3. The lower surface of the support rubber 3 connected with the lower end of the through hole 30 is configured as a supported surface (a surface supported by the support 20) inclined downward toward the outer circumferential side. However, the slope of the supported surface is smaller than a chevron-shaped support surface formed at the upper end of the support 20. This is because a gap allowing the electronic percussion instrument 1 to able to swing is formed between the upper surface of the support 20 and the lower surface of the support rubber 3.

However, with the support structure of the conventional electronic percussion instrument, issues as follows may arise. First, when the center of gravity of the electronic percussion instrument 1 is at a position deviated from the central axis of the through hole 30 (the rod 2), the electronic percussion instrument 1 is inclined with respect to the rod 2 by the amount of the gap between the upper surface of the support 20 and the lower surface of the support rubber 3. That is, the percussion electronic instrument 1 cannot be horizontally supported by the rod 2. Second, when the support 20 and the support rubber 3 repetitively contact and separate when the electronic percussion instrument 1 swings due to percussions, a sensor (which detects the vibration of the percussion to the electronic percussion instrument) may erroneously detect the vibration resulting from the contact.

Comparatively, the electronic percussion instrument 200 of the embodiment includes a support structure capable of addressing such issues. The support structure is described with reference to FIGS. 7 to 9. Firstly, the schematic configuration of the rod 500 and the case 207 supported by a support 501 of the rod 500 is described with reference to FIGS. 7 and 8. FIG. 8 is an exploded perspective view illustrating the electronic instrument 200, the rod 500 and the support 501. In the enlarged portion on the left side of FIG. 7, a state in which the electronic percussion instrument 200 is removed from the rod 500 (the support 501) is shown, and the hatching of the cross-section is omitted from the illustration. In addition. FIG. 8 illustrates a state in which the case 207 is removed from the main body frame 201 of the electronic percussion instrument 200.

As shown in FIGS. 7 and 8, the support 501 is installed to the rod 500 having a rod shape and supporting the electronic percussion instrument 200. The support 501 is formed in a cylindrical shape having a mounting hole 510 at the center. In the support 501, inclined surfaces 512 inclined downward from the upper end side of the support 501 toward an outer circumferential surface 511 are formed. The inclined surfaces 512 sandwich the rod 500 to be formed symmetrically as a pair, and the upper ends of the pair of inclined surfaces 512 are connected by a curved surface 513 (see FIG. 8). The curved surface 513 is a curved surface that is convex upward, and, with the inclined surfaces 512 and the curved surface 513, a chevron-shaped support surface supporting the case 207 of the electronic percussion instrument 200 is formed.

On the upper surface part 210 of the main body frame 201, a circular insertion hole 214 is formed, and an inserted part 270 of the case 207 is inserted into the insertion hole 214. The inserted part 270 is formed in a cylindrical shape, and a projection part 271 projects like a flange from the lower end of the inserted part 270. A bottom wall part 272 (see FIG. 8) of the case 207 is connected with the outer circumferential surface of the projection part 271, and an outer wall part 273 protrudes upward from the outer edge of the bottom wall part 272.

The case 207 is installed to the main body frame 201 through screw-fastening using a bolt not shown herein in a state in which the inserted part 270 is inserted into the insertion hole 214 of the main body frame 201 (the upper surface part 210). In the installed state of the case 207, a space surrounded by the lower surface of the upper surface part 210 of the main body frame 201, the bottom wall part 272, and the outer wall part 273 is formed, and electronic components, such as a substrate, is accommodated in the space.

The inner circumferential side of the inserted part 270 is blocked by the supported part 274 having a rod insertion hole 274a at the center, and the respective parts 270 to 274 forming the case 207 are formed integrally by using an elastic material, such as rubber or elastomer (synthetic resin).

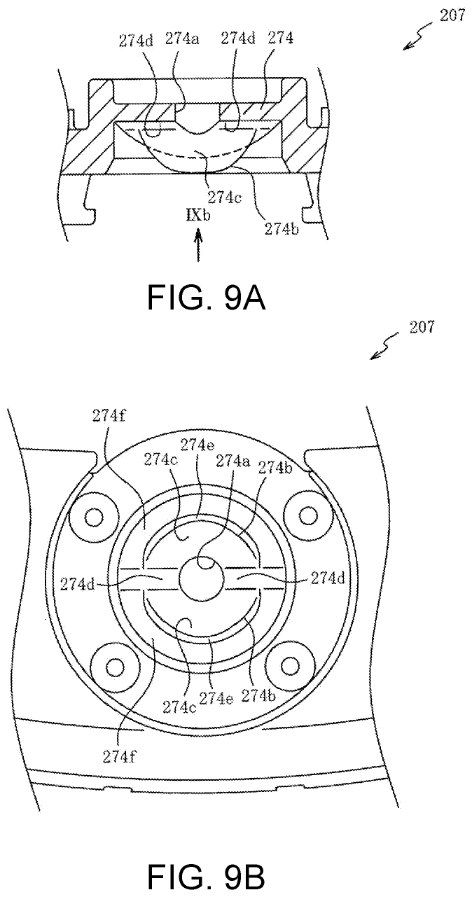

In the following, the detailed configuration of the supported part 274 is described with reference to FIG. 7 and (a) and (b) of FIG. 9. (a) of FIG. 9 is a partially enlarged cross-sectional view illustrating the case 207 and taken along a line IXa-IXa of FIG. 7, and (b) of FIG. 9 is a partially enlarged lower view illustrating the case 207 when viewed in a direction of an arrow IXb in (a) of FIG. 9. In the enlarged portion on the left side of FIG. 7 and (a) of FIG. 9, the lower surface of the supported part 274 (a portion where protrusions 274b are not formed) hidden in the protrusions 274b is shown by a broken line.

As shown in FIG. 7 and (a) and (b) of FIG. 9, the protrusions 274b protruding downward are formed on the lower surface of the supported part 274. The protrusions 274b sandwich the rod insertion hole 274a to be formed as a pair, and inner circumferential surfaces 274c of the pair of protrusions 274b are connected by a curved surface 274d. The curved surface 274d is a curved surface convex upward, and the inner circumferential surfaces 274c and the curved surface 274d are supported surfaces supported by the inclined surface 512 and the curved surface 513 (see FIG. 8) of the support 501.

The inner circumferential surface 274c of the protrusion 274b is a flat surface inclined downward from the lower end of the rod insertion hole 274a toward the outer circumferential side (a direction away from the rod insertion hole 274a), and the inclination angle of the inner circumferential surface 274c with respect to the central axis of the rod insertion hole 274a (the axial center of the rod 500) is set to be the same as (or smaller than) the inclination angle of the inclined surface 512 of the support 501 with respect to the axial center of the rod 500. Accordingly, in the state in which the rod 500 is inserted into the insertion hole 274a and the supported part 274 is supported by the support 501 (referred to as “the supported state of the supported part 274), the inner circumferential surface 274c of the protrusion 274b is in surface contact with the inclined surfaces 512 of the support 501 (see FIG. 7).

In addition, the curvature of the curved surface 274d of the supported part 274 is the same as the curvature of the curved surface 513 (see FIG. 8) of the support 501. Accordingly, while not shown in the drawings, in the supported state of the supported part 274, the curved surface 274d is in surface contact with the curved surface 513 of the support 501.

In this way, the supported part 274 of the embodiment includes the insertion hole 274a into which the rod 500 is inserted and the protrusions 274b protruding downward from the periphery of the lower end of the rod insertion hole 274a, and the protrusion 274b includes the inner circumferential surface 274c (the supported surface) in contact with the inclined surfaces 512 (the support surfaces) of the support 501. That is, since the protrusions 274b (third elastic bodies) made of rubber are interposed between the supported part 274 and the inclined surfaces 512 of the support 501, in the state before the electronic percussion instrument 200 is percussed, the inclination of the electronic percussion instrument 200 with respect to the rod 500 can be regulated by the protrusions 274b (see FIG. 7). Accordingly, even in the case where the center of gravity of the electronic percussion instrument 200 is deviated from the center of the rod insertion hole 274a (the axial center of the rod 500), the electronic percussion instrument 200 is easily supported horizontally with respect to the rod 500.

At the time when the head 202 of the electronic percussion instrument 200 is percussed from such supported state, the swinging of the electronic percussion instrument 200 is allowed due to the elastic deformation of the protrusions 274b (third elastic bodies). Specifically, a groove 274f surrounding outer circumferential surfaces 274e of the protrusions 274b is formed on the lower surface of the supported part 274. Accordingly, at the time when the head 202 located on the side (the right side in FIG. 7) opposite to the rod 500 (the rod insertion hole 274a) across the protrusion 274b is percussed, the deformation of the protrusions 274b occurring together with the percussion can be received by the groove 274f. Due to the deformation of the protrusions 274b, it is possible for the electronic percussion instrument 200 to swing with respect to the rod 500 (the support 501).

When the electronic percussion instrument 200 swings, the pair of protrusions 274b repetitively and alternately deform elastically. However, at the time of the elastic deformation, the close contact state between the inclined surfaces 512 of the support 501 and the inner circumferential surfaces 274c of the protrusions 274b is maintained. That is, different from the conventional art, the repetitive contacts and separations between the support 501 and the supported part 274 (the protrusions 274b) at the time when the electronic percussion instrument 200 swings can be suppressed. Accordingly, the erroneous detection of the vibration by the head sensor S1 resulting from such contact can be suppressed.

Here, when the plate-shaped upper surface part 210 (see FIG. 5) of the main body frame 201 is integrally formed with the arced part 211 like the electronic percussion instrument 200 of the embodiment, an issue that noise is produced due to the vibration propagated to the upper surface part 210 at the time of the percussion to the head 202 or the cover 206 (see FIG. 8) arises. Comparatively, for example, in a configuration in which a percussed part 22 (first frame) that receives a percussion and a frame 44 (second frame) forming the upper surface of an electronic percussion instrument together with a percussion surface 22a of the percussed part 22 are separate components like Japanese Laid-open No. 2017-026726, such noise cannot be sufficiently suppressed.

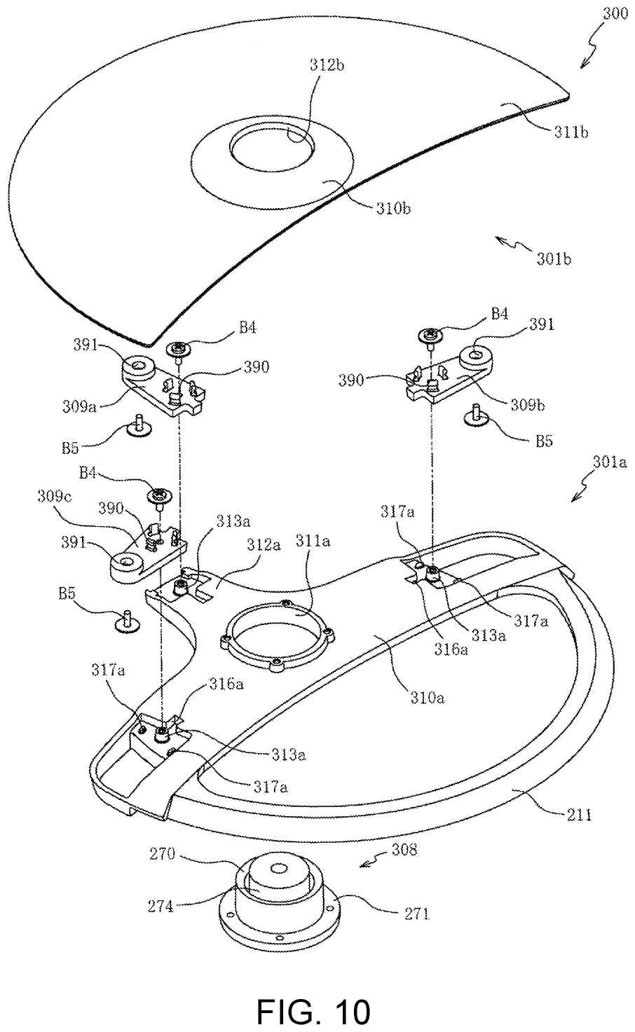

An electronic percussion instrument 300 of the third embodiment addressing the above issue is described with reference to FIGS. 10 to 12. Parts same as those of the electronic percussion instrument 200 of the second embodiment described above are described by assigning the same reference numerals, and the description thereof is omitted.

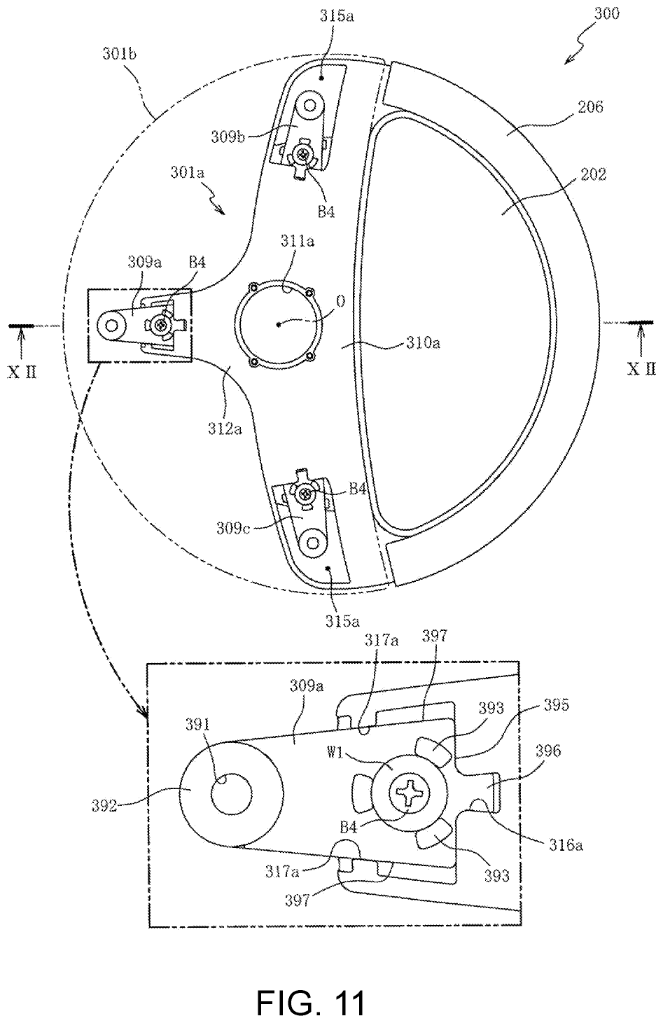

Firstly, the overall configuration of the electronic percussion instrument 300 is described with reference to FIGS. 10 and 11. FIG. 10 is an exploded perspective view illustrating the electronic percussion instrument 300 according to the third embodiment. FIG. 11 is a top view of the electronic percussion instrument 300. FIG. 10 illustrates the state in which the cover 206 (see FIG. 11) is removed from the arced part 211 of a first frame 301a, whereas FIG. 11 illustrates a state in which the cover 206 is installed to the arced part 211. Also, FIG. 11 illustrates the outer shape of a second frame 301b by using a two-dot chain line.

As shown in FIGS. 10 and 11, the electronic percussion instrument 300 of the third embodiment includes the first frame 301a and the second frame 301b. The first frame 301a includes the arced part 211 (see FIG. 10) same as the second embodiment, and the second frame 301b is connected to be overlapped with the first frame 301a.

In the following description, a portion of the first frame 301a to which the second frame 301b is fixed (a portion covered by the second frame 301b) is described as a fixing part 310a.

The fixing part 310a extends in the horizontal direction (the upper-lower direction of FIG. 11) to connect the two ends of the arced part 211, and the fixing part 310a and the arced part 211 are integrally formed by using a resin material. When the direction (the upper-lower direction of FIG. 11) in which the fixing part 310a extends from an end of the arced part 211 to the other end is set as the longitudinal direction, an insertion hole 311a having a circular shape is formed in the central portion of the fixing part 310a in the longitudinal direction, and an inserted part 270 of a support rubber 308 (see FIG. 10) is inserted into the insertion hole 311a.

In the first frame 301a (the fixing part 310a), a recess for accommodating electronic components, such as a substrate, is formed on the periphery of the insertion hole 311a. However, the electronic components as well as the recess are omitted in FIGS. 10 and 11.

The support rubber 308 has substantially the same configuration as the case 207 of the second embodiment, except that the bottom wall part 272 and the outer wall part 273 (see FIG. 8) of the second embodiment are omitted. That is, like the case 207 of the second embodiment, the support rubber 308 includes the projection part 271 like a flange and hooked to the edge of the lower end side of the insertion hole 311a, and the supported part 274 supported by the rod 500 via the support 501 (see FIG. 8).

In addition, while not shown in the drawings, the female screw holes 212 (see the enlarged portion of FIG. 6) same as the second embodiment are also formed on the lower surfaces of the fixing part 310a and the arced part 211. By screw-fastening the base frame 205 (see FIG. 6) to the female screw holes 212, the head 202 (see FIG. 11) serving as the percussion surface is accommodated in the opening portion having a semicircular shape and surrounded by the fixing part 310a and the arced part 211. That is, the first frame 301a supports the head 202 from a peripheral side, and is adjacent to the head 202a to surround the head 202a. Accordingly, like the second embodiment, the vibration at the time of the percussion to the head 202 is detected by the head sensor S1 (see FIG. 6), and the head sensor S1 is supported by the first frame 301a via the support frame 204 and the base frame 205.

In this way, the first frame 301a formed by the fixing part 310a and the arced part 211 is a frame that forms the skeleton of the percussion region (percussion surface) percussed by the performer. Meanwhile, although the second frame 301b connected to be overlapped with the first frame 301a is a frame forming the upper surface of the electronic percussion instrument 300 together with the head 202 and the cover 206 (percussion surface), no sensor is installed to the second frame 301b. That is, the second frame 301b is a decorative frame for creating, together with the first frame 301a, a disc-shaped electronic percussion instrument 300 resembling a cymbal (for improving the appearance of the electronic percussion instrument 300). The upper surface of the second frame 301b is a non-percussion surface not assumed to receive a percussion.

The second frame 301b is formed in a semicircular shape having a bell part 310b and a bow part 311b resembling an acoustic cymbal, and the bell part 310b and the bow part 311b are integrally formed by using a resin material. An insertion hole 312b having a circular shape and provided to be inserted by the rod 500 (see FIG. 8) is formed at the center of the bell part 310b. The bell part 310b is formed in a bowl shape inclined downward toward the outer circumferential side from the insertion hole 312b.

The bowl part 311b is formed in a plate shape inclined downward from the outer edge of the bell part 310b toward the outer circumferential side, and the bow part 311b is supported by the first frame 301a via elastic bodies 309a to 309c. In the supported state, the second frame 301b does not contact the first frame 301a, and the elastic bodies 309a to 309b are formed by using a material (rubber, elastomer, etc.) softer than the respective frames 301a, 301b.

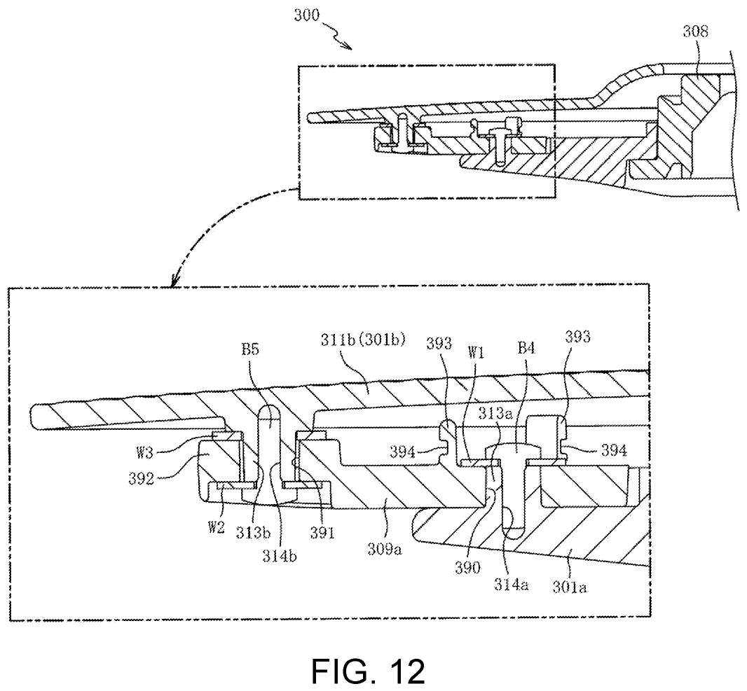

While details about the support structure (see FIG. 12) of the second frame 301b from the elastic bodies 309a to 309c will be described afterwards, the vibration propagated from the first frame 301a to the second frame 301b at the time of the percussion to the head 202 or the cover 206 (see FIG. 11) can be attenuated by elastically supporting the second frame 301b on the first frame 301a via the elastic bodies 309a to 309c. Thus, since the noise produced due to the vibration of the second frame 301b can be suppressed, the performer is allowed a favorable feeling of performance.

The elastic bodies 309a to 309c are formed in a semi-elliptical shape in a plan view. In the following description, the long diameter directions of the elastic bodies 309a to 309c (e.g., the left-right direction of the elastic body 309a in FIG. 11) are described as “longitudinal direction”, and the short-diameter directions (e.g., the upper-lower direction of the elastic body 309a in FIG. 11) are described as “width direction”. Pairs of through holes 390, 391 (see FIG. 10) are formed in the upper-lower direction on the two end sides of the elastic body 309 in the longitudinal direction.

The through holes 390 are holes for fixing the base end portions (one end side) of the elastic bodies 309a to 309c to the first frame 301a, and the through holes 391 are holes for fixing the second frame 301b to the tip end portions (the other end side) of the elastic bodies 309a to 309c.

A protrusion part 312a protruding toward a side opposite to the head 202 by sandwiching the insertion hole 311a is integrally formed at the fixing part 310a of the first frame 30, and a fixing protrusion 313a having a circular columnar shape is erected from the upper surface of the tip end side of the protrusion part 312a. In addition, the same fixing protrusions 313a are also formed on the two end sides of the fixing part 310a in longitudinal direction and sandwiching the insertion hole 311a of the first frame 310a.

The elastic bodies 309a to 309c are fixed to the first frame 301a by using bolts B4 screwed into the fixing protrusions 313a. Also, the second frame 301b is fixed to the elastic bodies 309a to 309c by using bolts B5 (see FIG. 10) inserted into the through holes 391 of the elastic bodies 309a to 309c. The fixing structure is described with reference to FIGS. 11 and 12. FIG. 12 is a partially enlarged cross-sectional view illustrating the electronic percussion instrument 300 and taken along a line XII-XII of FIG. 11.

Although the following mainly describes the fixing structure of the second frame 301b by using the elastic body 309a, the fixing structures of the second frame 301b by using the elastic bodies 309b and 309c have substantially the same configuration.

As shown in FIGS. 11 and 12, a female screw hole 314a is formed in each fixing protrusion 313a (see the enlarged portion of FIG. 12), and the elastic body 309a is fixed to the first frame 301a by screwing the bolt B4 into the female screw hole 314a in the state in which the through holes 390 of the elastic bodies 309a to 309c are fit with the fixing protrusions 313a. In the fixed state, the upward displacement of the fixing protrusion 313a (the falling out of the elastic body 309a from the fixing protrusion 313a of the first frame 301a) is restricted by using a washer W1 sandwiched between the upper surface of the fixing protrusion 313a and the head of the bolt B4. It is noted that the thickness of the elastic body 309a on the periphery of the fixing protrusion 313a is formed to be the same as the height of the fixing protrusion 313a.

A supporting convex part 392 having a circular columnar shape is erected from the upper surface of the tip end side of the elastic body 309a (the left side of FIG. 12), and the through hole 391 is formed in the support convex part 392. The fixing protrusion 313b having a circular columnar shape and inserted into the through hole 391 of the elastic body 309a protrudes downward from the lower surface of the second frame 301b (the bow part 311b). Multiple fixing protrusions 313b (at three places in the embodiment) are formed in the second frame 301b, and the fixing protrusions 313b are respectively formed at positions (positions at which the fixing protrusions 313b can be inserted into the through holes 391) corresponding to the three elastic bodies 309a to 309c fixed to the first frame 301a.

A female screw hole 314b is formed in the fixing protrusion 313b, and, in the state in which the fixing protrusion 313b is inserted into the through hole 391 of the elastic body 309a, the second frame 301b is fixed to the elastic body 309a by screwing the bolt B5 into the female screw hole 314b. In the fixed state, the upward displacement of the second frame 301b (the falling out of the second frame 301b from the through hole 391 of the elastic body 309a) is restricted by using a washer W2 sandwiched between the lower surface of the fixing protrusion 313b and the head of the bolt B5.

Although a washer W3 is also sandwiched between the support convex part 392 of the elastic body 309a and the lower surface of the second frame 301b, the thickness of the elastic body 309a between the washers W2 and W3 sandwiching the support convex part 392 at the upper part and the lower part is the same as the interval between the washers W2, W3.

Accordingly, in the embodiment, although the second frame 301b is elastically supported by the three elastic bodies 309a to 309c (see FIG. 11), the elastic body 309a fixed to the protrusion part 312a of the first frame 301a, among the three elastic bodies 309a to 309c, protrudes toward the outer circumferential side with respect to the protrusion tip end of the protrusion part 312a, and is fixed to the first frame 301a in the cantilevered state.

In addition, although the pair of elastic bodies 309b. 309c are fixed to two end sides of the fixing part 310a in the longitudinal direction (the upper-lower direction of FIG. 11), a through hole 315a penetrating through the fixing part 310a is formed on the other end side of each of the pair of elastic bodies 309b, 309c. That is, the elastic bodies 309b. 309c are also fixed to the first frame 301a in the cantilevered state.

In this way, in the embodiment, the base end sides of the elastic bodies 309a to 309c are fixed to the first frame 301a in the cantilevered state, whereas the second frame 301b is fixed to the tip end sides of the elastic bodies 309a to 309c. Accordingly, at the time when the first frame 301a swings with respect to the rod 500 (see FIG. 8) at the time of the percussion to the head 202 or the cover 206, while the entireties of the elastic bodies 309a to 309c are deformed to bend, the second frame 301b follows the swinging of the first frame 301a by using the restoring force of the elastic bodies 309a to 309c together with the deformation. That is, the second frame 301b can be swung relatively with respect to the first frame 301a.

By allowing the relative swinging of the second frame 301b with respect to the first frame 301a, it is easy to swing only the first frame 301a (the swinging of the second frame 301b can be reduced) at the time of the percussion to the head 202 or the cover 206. Accordingly, the noise produced due to the swinging (vibration) of the second frame 301b can be effectively reduced.

Since the elastic bodies 309a to 309c are fixed to the respective frames 301a. 301b by using the bolts B4, B5, in order to stably (firmly) hold the elastic bodies 309a to 309c by using the fixing portions, the elastic bodies 309a to 309c may be formed by using rubber with a higher hardness. Meanwhile, if the hardness of the rubber is too high, it is difficult to bend the elastic bodies 309a to 309c, and therefore it becomes harder to swing the second frame 301b relatively with respect to the first frame 301a.

Comparatively, the elastic bodies 309a to 309c of the embodiment are formed in plate shapes in which the thickness in the upper-lower direction is smaller than the thickness in the width direction. Accordingly, even in the case where the elastic bodies 309a to 309c are formed by using rubber with a higher hardness, it is easy to bend the elastic bodies 309a to 309c in the upper-lower direction. Accordingly, the elastic bodies 309a to 309c can be stably held at the fixing portions by using the bolts B4, B5, and the second frame 301b can be swung easily with respect to the first frame 301a.

In addition, it is configured that, when the second frame 301b swings with respect to the first frame 301a, the second frame 301b does not contact components (e.g., the head 202, the cover 206, the support rubber 308, etc.,) other than the elastic bodies 309a to 309c (including the bolts B5 and the washers W2, W3). By avoiding such contact, the sounds of the collision between the second frame 301b and other components can be suppressed, or the sensor S1 can be suppressed from erroneously detecting the vibration due to such collision, and the damages of the second frame 301b (other components) can be suppressed.

Here, the elastic bodies 309a to 309c protrude in radial directions with the center of the insertion hole 311a of the third frame 301a, that is, the swing axis O (see FIG. 11) of the electronic percussion instrument 300, as the center. This is because the entire second frame 301b is uniformly swung in the upper-lower direction with respect to the swinging of the first frame 301a at the time of the percussion to the head 202.

That is, for example, it is also possible to orient the tip ends of the pair of elastic bodies 309b, 309c among the elastic bodies 309a to 309c in the same direction (the left side of FIG. 11) as the elastic body 309a. However, in such configuration, the second frame 301b may tend to swing to sink (or rise) toward the protrusion direction side (the left side of FIG. 11) of each of the elastic bodies 309a to 309c, among the radial directions with the swing axis O as the center. That is, only the region of a portion of the second frame 301b swings easily in the upper-lower direction, while it is difficult to generate such swing in other regions.

When only the region of a portion of the second frame 301b swings significantly in the upper-lower direction, the respective frames 301a, 301b come into contact in such region, and the feeling of performance deteriorates due to the sounds of collision, or the respective frames 301a, 301b are damaged easily. In addition, the head sensor S1 may erroneously detect the vibration due to the collision of the respective frames 301a. 301b. In order to prevent the respective frames 301a. 301b from coming into contact in this way, if the interval between the respective frames 301a, 301b in the upper-lower direction is increased, the thickness of the electronic percussion instrument 300 itself is increased, and the resemblance with the acoustic cymbal deteriorates.

Comparatively, in the embodiment, it is configured that the elastic bodies 309a to 309c protrude in the radial directions with the swing axis O as the center. That is, since the radial directions with the swing axis O as the center conform to the longitudinal directions of the elastic bodies 309a to 309c, at the time of the percussion to the head 2 (see FIG. 11), the entire second frame 301b may move uniformly in the upper-lower direction with respect to the first frame 301a. Accordingly, compared with the case where only the region of a portion of the second frame 301b swings easily in the upper-lower direction, the contact between the respective frames 301a, 301b can be suppressed, while the interval of the respective frames 301a, 301b in the upper-lower direction can be narrowed as much as possible. Accordingly, the sounds of collision of the respective frames 301a. 301b can be suppressed from being produced, or the respective frames 301, 301b can be suppressed from being damaged, while the electronic percussion instrument 300 with a flat thickness resembling an acoustic cymbal can be formed.

In addition, although it is also possible to fix the elastic bodies 309a to 309c to the lower surface side of the first frame 301a, the elastic bodies 309a to 309c are fixed to the upper surface side of the first frame 301a. This is to improve the appearance by suppressing a portion of the elastic bodies 309a to 309c or the fixing portions (the bolts B4 and the washers W1) thereof from being exposed.

Meanwhile, when the elastic bodies 309a to 309c are fixed to the upper surface side of the first frame 301a by using the bolts B4, the bolts B4 may contact the second frame 301b when the second frame 301b swings in the upper-lower direction.

Comparatively, in the embodiment, as shown in the enlarged portion of FIG. 12, a buffering protrusion 393 protruding toward the second frame 301b is integrally formed on the upper surface of the elastic body 309a. Since the buffering protrusion 393 is formed in the periphery of the head of the bolt B4 (the washer W1), when the second frame 301b swings in the upper-lower direction, the contact between the bolt B4 and the second frame 301b can be restricted by the buffering protrusion 393. Accordingly, the production of the sounds of collision due to such contact and the damage of the second frame 301b can be suppressed, and the head sensor S1 can be suppressed from erroneously detecting the vibration due to such collision.

When the direction around the bolt B4 is set as the circumferential direction, three buffering protrusions (see the enlarged portion of FIG. 11) are formed equidistantly in the circumferential direction of the bolt B4. By surrounding the bolt B4 with the buffering protrusions 393, for example, the contact area between the buffering protrusions 393 and the second frame 301b can be reduced as compared to the case where the buffering protrusion 393 is formed in a continuous annular shape along the circumferential direction of the bolt B4, for example. Accordingly, the noise that is produced when the collision between the buffering protrusions 393 and the second frame 301b occurs can be reduced.

The dimension of the buffering protrusion 393 in a direction orthogonal to the axis of the bolt B4 is formed to be smaller than the dimension of the buffering protrusion 393 in the circumferential direction of the bolt B4. That is, the respective buffering protrusions 393 are formed to exhibit plate-shapes surrounding the bolt B4, and a groove 394 (see the enlarged portion of FIG. 12) is formed on the outer circumferential surface of each of the buffering protrusions 393 to face the opposite side with respect to the bolt B4. The groove 394 deforms the buffering protrusion 393 toward the opposite side with respect to the bolt B4 or the washer W1 when the buffering protrusion 393 and the second frame 301 come into contact.

That is, in the case of a configuration where the groove 394 is not formed in the buffering protrusion 393, for example, when contacting the second frame 301b, the buffering protrusion 393 may be deformed to fall toward the side of the bolt B4 (the washer W1). When the buffering protrusion 393 contacts the bolt B4 or the washer W1 due to such deformation, the buffering protrusion 393 may be damaged easily.

Comparatively in the embodiment, the groove 394 is formed on the outer circumferential surface of the buffering protrusion 393, and the groove 394 extends over the two ends of the buffering protrusion 393 in the circumferential direction of the bolt B4. Accordingly, since the buffering protrusion 393 can be suppressed from being deformed toward the side of the bolt B4 (the washer W1) when contacting the second frame 301b, the buffering protrusion 393 can be suppressed from contacting the bolt B4 or the washer W1. Accordingly, even if the second frame 301b and the buffering protrusion 393 come into contact repetitively, the buffering protrusion 393 is hardly damaged.

Here, when the first frame 301a swings at the time of the percussion to the head 202, the second frame 301b may rotate with respect to the first frame 301a in addition to swinging with respect to the first frame 301a in the upper-lower direction. When the second frame 301b contacts other components (e.g., the head 202 or the cover 206) due to such rotation, issues such as the production of noise or the damage of other components may occur, whereas when the gap between the second frame 301b and other components is increased to avoid such contact, the size of the electronic percussion instrument 300 increases, or the appearance deteriorates.

Accordingly, the relative rotation of the second frame 301b with respect to the first frame 301a may be restricted, and, as a means for restricting such rotation, for example, it is possible to adopt a configuration in which a concave shape and a convex shape fittable with each other are formed in the through hole 390 (see the enlarged portion of FIG. 12) and the fixing protrusion 313a. As an example of such configuration, a configuration in which the cross-sectional shapes of the through hole 390 and the fixing protrusion 313a are polygonal is exemplified. Also, as another example, a configuration in which multiple wall-shaped convex parts arranged in the circumferential direction are formed on the outer circumferential surface of the fixing protrusion 313a, and concave parts with which the convex parts are fittable are formed on the inner circumferential surface of the through hole 390 is exemplified.

However, in the configuration in which concave and convex parts fittable to each other are formed in the through hole 390 and the fixing protrusion 313a, that is, a configuration in which the concave and convex parts are fit in the vicinity of the fixing protrusion 313a, a load acting on the portion where the concave and convex parts are fit at the time of the rotation of the elastic bodies 309a to 309c may tend to increase. When the load acting on the fit portion of the concave and convex parts increases, the elastic bodies 309a to 309c may be damaged easily at the concave and convex portions, and the elastic bodies 309a to 309c may overcome the fitting force of the concave and convex parts and be rotated easily. Therefore, in the embodiment, a configuration in which the rotation of the elastic bodies 309a to 309c is restricted at a position away from the fixing protrusion 313a is adopted. The configuration is described in the following.

As shown in the enlarged portion of FIG. 11, a restricting protrusion 396 in a substantially rectangular shape when viewed in a plan view protrudes from a base end surface 395 of the elastic body 309a. Meanwhile, a restricting wall 316a having a wall shape coming into contact with the base end surface 395 and surrounding the restricting protrusion 396 is integrally formed on the upper surface of the first frame 301a (the fixing part 310a and the protrusion part 312a). The restricting wall 316a is formed along the base end surface 395 of the elastic body 309a and the outer circumferential surface of the restricting protrusion 396. Accordingly, the rotation of the elastic body 309a around the fixing protrusion 313a (see FIG. 12) can be restricted by using the contact between the restricting wall 316a and the base end surface 395 of the elastic body 309a or the contact between the restricting wall 316a and the restricting protrusion 396 (the side surface of the restricting protrusion 396 toward the circumferential direction of the bolt B4).

In addition, wall-shaped restricting walls 317a along side surfaces 397 of the elastic body 309a facing the width direction are integrally formed on the upper surface of the first frame 301a, and the two sides of the elastic body 309a in the width direction are sandwiched by the pair of restricting walls 317a. By using the contact between the restricting walls 317a and the side surfaces 397 of the elastic body 309a, the rotation of the elastic body 309a around the fixing protrusion 313a can also be restricted.

The restricting walls 316a. 317a are also formed in the peripheries of the elastic bodies 309b, 309c (see FIG. 10), and the rotation of the elastic bodies 309a to 309c can be restricted by the restricting walls 316a, 317a. Hence, since the relative rotation of the second frame 301b with respect to the first frame 301a can be suppressed, even if the gap between the second frame 301b and other components (e.g., the head 202) is arranged to be smaller, the contact of the second frame 301b with other components due to the swinging at the time of the percussion to the head 202 can be suppressed. Accordingly, the production of noise due to the contact between the second frame 301b and other components can be suppressed, while the size of the electronic percussion instrument 300 can be suppressed from increasing or the appearance can be suppressed from deteriorating. In addition, the sensor S1 can be suppressed from erroneously detecting the vibration due to the contact between the second frame 301b and other components.

Also, in the embodiment, it is configured to restrict the rotation of the elastic bodies 309a to 309c by using the contact between the restricting walls 316a, 317a having a wall shape erected from the upper surface of the first frame 301a and the outer circumferential surfaces (the base end surface 395, the side surface of the restricting protrusion 396, and the side surfaces 397) of the elastic bodies 309a to 309c. According to such configuration, the rotation of the elastic bodies 309a to 309c can be restricted at positions away from the fixing protrusions 313a.

Accordingly, the load acting on the fit portions between the restricting walls 316a and the restricting protrusions 396 when the elastic bodies 309a to 309c rotate can be reduced. Accordingly, the rotation of the elastic bodies 309a to 309c can be restricted, while cracks can be suppressed from being generated at the connected portions (root portions of the limiting protrusions 396) between the base end surfaces 395 and the restricting protrusions 396 of the elastic bodies 309a to 309c. In addition, since the load acting on the contact portions between the base end surfaces 395 or the side surfaces 397 of the elastic bodies 309a to 309c and the restricting walls 316a. 317a can be reduced, the rotation of the elastic bodies 309a to 309c can be restricted while the elastic bodies 309a to 309c can be suppressed from being damaged.

Although the above has been described based on the above embodiments, the invention is not limited to the above embodiments, and it can be easily understood that various improvements and modifications can be made without departing from the scope of the invention.

In the respective embodiments, as an example of the configuration in which the head 1. 202 is air-permeable, the case where a mesh made of synthetic fibers is used is described. However, the invention is not limited thereto. For example, the head 1, 202 may also be made of other air-permeable materials such as cloth, non-woven fabric, or film with perforations, and the head 1, 202 may also be configured to be not air-permeable (e.g., forming the head 1, 202 by using a film made of synthetic resin).

In the respective embodiments, the case where the elastic body 3, 20 is formed by using an elastic material exhibiting a hardness of 10 or more and 50 or less as measured with a durometer type A hardness tester or a foamed material exhibiting a hardness of 20 or more and 75 or less as measured with a durometer type E hardness tester is described. However, the invention is not limited thereto. For example, the elastic body 3, 203 may also be formed by using a material harder or softer than the above hardness.

In the respective embodiments, the case where the elastic body 3, 203 is a single layer is described. However, the invention is not limited thereto. For example, it may also be configured that multiple elastic bodies 3, 203 are stacked in the upper-lower direction, and in the multiple layers of elastic bodies 3, 203, one or more layers of the elastic bodies 3, 203 may also be formed with a hardness different from the hardness of other elastic bodies 3, 203.

In the respective embodiments, the case where the through holes 32, 231 having a honeycomb shape (hexagonal cross-section) or a circular cross-section are scattered in the elastic body 3, 203 is described. However, the invention is not limited thereto. For example, the through holes 32, 231 may also be elongated holes combining linear or curved lines, and it may also be configured that the through holes 32, 231 having the elongated shape are combined (connected) with the through holes 32, 231 having a honeycomb shape (or other polygonal shapes) or a circular cross-section.

Although the description is omitted in the respective embodiments, in the region in which the through holes 32, 231 are not formed, the upper surface and the lower surface of the elastic body 3, 203 may be a flat surface, and a concave part, a convex part or a groove may also be formed in at least one (or both) of the upper surface and the lower surface of the elastic body 3, 203.

Although the description is omitted in the respective embodiments, when the opening ratio (the proportion of the opening area of the through holes 32, 231 with respect to the area of the elastic body 3, 203) is excessively low, the elastic body 3, 203 becomes excessively hard, and it is difficult to reduce the percussion sound at the time of the percussion to the head 1, 202. Meanwhile, when the opening ratio of the through holes 32, 231 is excessively high, the elastic body 3, 203 becomes excessively soft, and it is difficult for the vibration at the time of the percussion to the head 1, 202 to be propagated to the head sensor S1. Accordingly, the opening ratio of the through holes 32, 231 in the elastic body 3, 203 may be 20% or higher and 80% or lower. Accordingly, the percussion to the head 1, 202 can be accurately detected, while the percussion sound at the time of the percussion to the head 1, 202 can be reduced.

In the first embodiment, the case where the head sensor S1 is installed to the sensor support member 4 is described, and in the second embodiment, the case where the head sensor S1 is installed to the lower surface of the support frame 204 is described. However, the invention is not limited thereto. For example, in the first embodiment, the head sensor S1 may also be directly installed to the upper surface or the lower surface of the support part 20. In addition, for example, in the second embodiment, it may also be configured that the sensor support member 4 to which the head sensor S1 is installed is fixed to the lower surface of the support frame 204, or it may also be configured that the head sensor S1 is directly installed to the upper surface of the support frame 204.

In the respective embodiments, the case where the elastic body 3, 203 contacts the head 1, 202 in the state before the percussion is described. However, the invention is not limited thereto. If it is configured that the elastic body 3, 203 contacts the head 1, 202 at least at the time of the percussion to the head 1, 202, it may also be that a portion or the entirety of the elastic body 3, 203 does not contact the head 1, 202 in the state before the percussion.

In the respective embodiments, the through hole 26, 241 having a honeycomb shape (a hexagonal cross-section) extending in the upper-lower direction are formed in the body part 2 (the support part 20) or the support frame 204, and the cross-sectional area (inner diameter) of the through hole 26, 241 is constant from the upper end to the lower end. However, the invention is not limited thereto. For example, the through hole 26, 241 may also be inclined with respect to the thickness direction (upper-lower direction) of the support part 20 or the support frame 204, and the cross-sectional shape of the through hole 26, 241 may also be other polygonal shapes or a circular shape. In addition, it may also be configured that the cross-sectional area (inner diameter) of the through hole 26, 241 changes in a portion or the entirety of the region of the through hole 26, 241 from the upper end to the lower end. In addition, the through holes 26, 241 may also be omitted.

In the first embodiment, the case where the outer frame member 5 supports the body part 2 via the elastic body 6 is described. However, the invention is not limited thereto. For example, it may also be configured to omit the outer frame member 5 or the elastic body 6. In the case of such configuration, by installing a rim sensor (e.g., a sheet-like membrane switch) to the head frame 10, the electronic percussion instrument 100 resembling an acoustic drum can be formed.

In the first embodiment, the case where the support position of the elastic body 6 by the outer frame member 5 (the bottom part 51) is located on the inner circumferential side with respect to the support position of the body part 2 (the bottom wall 22) by the elastic body 6. However, the invention is not limited thereto. For example, by locating the support position of the elastic body 6 by the outer frame member 5 on the outer circumferential side with respect to the support position of the body part 2 by the elastic body 6 (the outer frame member 5 is fixed to the outer edge side of the elastic body 6, and the body part 2 is fixed to the inner edge side of the elastic body 6), the support positions of the two points may also be shifted in the radial direction.

In the first embodiment, the case where the elastic body 6 is formed in an annular shape (being continuous in the circumferential direction) is described. However, the invention is not limited thereto. For example, it may also be configured that the body part 2 is supported by multiple elastic bodies 6 arranged (intermittently) along the circumferential direction.

In the first embodiment, the case where the percussion (vibration) to the rim 53 is detected by the rim sensor S2 (piezoelectric element) installed to the outer frame member 5 is described. However, the invention is not limited thereto. For example, the rim sensor S2 may be omitted, and the percussion to the rim 53 may be detected by a sheet-like pressure sensor (e.g., membrane switch) provided between the concave part 52 and the rim 53 of the outer frame member 5.

In the first embodiment (the modified example of the rim 53), as an example of the configuration in which the rim 53 (the base part 53a) is bonded to the outer circumferential part 50 (the concave part 52) of the outer frame member 5, the adhesion by an adhesive or a double-sided tape is exemplified. However, the invention is not limited thereto. For example, it may also be configured that the rim 53 (the base part 53a) is bonded to the outer circumferential part 50 (the concave part 52) of the outer frame member 5 by other conventional means, such as integral molding (vulcanization adhesion) using a mold, welding, etc. In such configuration as well, the fluttering of the rim 53 at the time of the percussion can be suppressed.

In the first embodiment (the modified example of the rim 53), the case where the rim 53 is bonded to the upper surface (the concave part 52) of the outer circumferential part 50 of the outer frame member 5 is described. However, the invention is not limited thereto. For example, the rim 53 may also be bonded to the side surface of the outer circumferential part 50 of the outer frame member 5.

In the first embodiment, the case where multiple convex parts 54 for allowing a downward displacement of the elastic body 6 (the body part 2) is described. However, the invention is not limited thereto. For example, the convex part 54 may also be formed continuously in the circumferential direction

In the second embodiment, the case where the support frame 204 is displaced upward by the bolt B3 and the head 202 is pushed upward by the elastic body 203 to apply a tension to the head 202 is described. However, the process of applying the tension may also be applied to the electronic percussion instrument 100 (an instrument resembling a drum) of the first embodiment.

In the second embodiment, as an example of the displacement means for pushing upward the support frame 204, the bolt B3 screwed into the support frame 204 (the head is mounted to the insertion hole 251 of the base frame 205) is exemplified. However, the invention is not limited thereto. For example, the support frame 204 may also be pushed upward by a shaft part of the bolt screwed into the base frame 205 from below. That is, the invention is not limited to the above configuration as long as it is configured that the support frame 204 can be relatively displaced with respect to the base frame 205.

In the second embodiment, the case where, in the state before the electronic percussion instrument 200 is percussed, the inner circumferential surfaces 274c (supported surfaces) of the protrusions 274b are in surface contact with the inclined surfaces 512 (support surfaces) of the support 501 is described. However, the invention is not limited thereto. For example, it may also be configured that, in the state before the electronic percussion instrument 200 is percussed, gaps are formed between the inner circumferential surfaces 274c of the protrusions 274b and the inclined surfaces 512 of the support 501 (applying the support structure of International Publication No. 2022/044171 to the electronic percussion instrument 200 of the second embodiment).

In the second embodiment, the protrusions 274b integrally formed at the supported part 274 are shown as an example of the elastic bodies (third elastic bodies) allowing the swinging of the electronic percussion instrument 200 at the time of the percussion while suppressing the inclination of the electronic percussion instrument 200 with respect to the rod 500 before the percussion. However, the invention is not limited thereto. For example, it may also be configured that elastic bodies (elastic bodies corresponding to the protrusions 274b) formed separately from the supported part 274 are interposed between the supported part 274 and the support 501 (the inclined surfaces 512).

In addition, as an example of the chevron-shaped support surface (referred to as “support surface” in the following) supporting the protrusions 274b, a configuration in which the pair of inclined surfaces 512, which are flat surfaces, are inclined downward toward the outer circumferential surface 511 of the support 501. However, the invention is not limited thereto. For example, a portion or the entirety of the pair of inclined surfaces 512 may be formed curved, and the support surfaces may be also be formed conical or hemispherical. In addition, it may also be configured that a horizontal surface (a flat surface orthogonal to the axial direction of the rod 500) is interposed between the support surfaces and the outer circumferential surface 511 of the support 501, that is, it may also be configured that the chevron-shaped support surface is formed in a convex shape erected from the horizontal surface. That is, the shape of the chevron-shaped support surface is not limited to the above configuration as long as it is configured that chevron-shaped support surface can support the protrusions 274b (third elastic bodies).

In the second embodiment, the case formed with the groove 274f surrounding the peripheries of the protrusions 274b is described. However, the groove 274 may be omitted.

In the third embodiment, the case where the elastic bodies 309a to 309c made of rubber are fixed to the first frame 301a in the cantilevered state is described. However, the invention is not limited thereto. For example, the entirety of the elastic bodies 309a to 309c may be supported by the first frame 301a, and other conventional elastic bodies, such as a coil spring or a plate spring, etc., may also be interposed between the respective frames 301a. 301b. That is, other conventional support structures can be applied as long as such structures allow the two frames (plate-shaped members) to be elastically connected with each other. As other conventional support structures, a configuration in which a first frame 41 is elastically supported with respect to a second frame 44 by using an elastic member 44b and a connection spring 45 as in Japanese Laid-open No. 2013-142872 is exemplified, and such support structure may also be applied to the respective frames 301a. 301b.

In the third embodiment, the case where the respective elastic bodies 309 are fixed to the respective frames 301a. 301b by using the bolts B4, B5 is described. However, the invention is not limited thereto. For example, it may also be that the bolts B4, B5 are omitted, and the elastic bodies 309a to 309c are bonded (adhered or welded) to the respective frames 301a, 301b. In such case, the restricting walls 316a, 317a (rotation restriction part) of the first frame 301a may also be omitted. That is, the means of fixing the elastic bodies 309a to 309c with respect to the respective frames 301a, 301b can be set as appropriate.

In the third embodiment, the case where the elastic bodies 309a to 309c are interposed between the respective frames 301a, 301b is described. However, the invention is not limited thereto. For example. (one) arced-shaped or annular-shaped elastic body that is continuous around the rod 500 may also be interposed between the respective frames 301a, 301b.

In the third embodiment, the case where the three elastic bodies 309a to 309c are the same components. However, the invention is not limited thereto. For example, in a region (a region where the elastic body 309a is disposed) sandwiching the rod 500 and being located on a side opposite to the head 202 (percussion surface), the second frame 301b may tend to swing significantly at the time of the percussion to the head 202 or the cover 206. Therefore, the rigidity (hardness or thickness in the upper-lower direction) of the elastic body 309a disposed in such region may be greater than the rigidity of the elastic bodies 309b, 309c.

In the third embodiment, the case where the second frame 301b (the inner circumferential surface of the insertion hole 312b) is not in contact with the rod 500 is described. However, the invention is not limited thereto. For example, it may also be configured that the rod 500 is supported by the second frame 301b via the support rubber 308. As an example of such configuration, a support structure of a bow frame 4 by using a support rubber 3 in International Publication No. 2022-044171 is exemplified.

In the third embodiment, the case where the elastic bodies 309a to 309c protrude in radial directions with the rod 500 as the center, that is, the case where the radial directions in which the swing axis O of the electronic percussion instrument 300 is set as the center conform to the longitudinal directions of the elastic bodies 309a to 309c. However, the invention is not limited thereto. For example, it may also be configured that the longitudinal directions of the elastic bodies 309a to 309c do not conform to (e.g., being inclined from) the radial directions with the swing axis O as the center.

In the third embodiment, the case where the elastic bodies 309a to 309c are formed to be semi-elliptical when viewed in a plan view is described. However, the invention is not limited thereto. For example, the elastic bodies 309a to 309c may also be rectangular or circular when viewed in a plan view. That is, the shapes of the elastic bodies 309a to 309c can be set as appropriate as long as the second frame 301b can be elastically supported with respect to the first frame 301a.

In the third embodiment, as an example of a part (contact restriction part) restricting the contact between the bolt B4 and the second frame 301b, multiple buffering protrusions 393 surrounding the bolt B4 are exemplified. However, the invention is not limited thereto. For example, the buffering protrusion 393 may also be formed in an annular shape that is continuous in the circumferential direction of the bolt B4. In addition, the contact between the bolts B4 and the second frame 301b may also be restricted by entirely increasing the thicknesses of the elastic bodies 309a to 309c around the bolts, instead of surrounding the bolts B4 may using protruding components. In addition, instead of restricting the contact between the bolts B4 and the second frame 301b by using the elastic bodies 309a to 309c, it may also be configured that a buffering material, such as rubber or cushion, restricting the contact thereof is provided in one or both of the respective frames 301a. 301b.

In the third embodiment, the case where the groove 394 is formed on the outer circumferential surface of the buffering protrusion 393 and extends over the two ends of the buffering protrusion 393 in the circumferential direction of the bolt B4 is described. However, the invention is not limited thereto. For example, the groove 394 may be formed intermittently in the circumferential direction of the bolt B4, and the groove 394 may also be formed in a length not reaching the two ends of the buffering protrusion 393 in the circumferential direction of the bolt B4.

In the third embodiment, the case where the rotation of the elastic bodies 309a to 309c is restricted by using the contact between the restricting walls 316a, 317a of the first frame 301a and the outer circumferential surfaces (the base end surfaces 395, the side surfaces of the restricting protrusions 396, and the side surfaces 397) is described. However, the invention is not limited thereto. For example, as another configuration restricting the rotation of the elastic bodies 309a to 309c, a configuration in which concave and convex parts fittable with each other are formed in the through hole 390 and the fixing protrusion 313a or a configuration in which the first frame 301a is bonded to the elastic bodies 309a to 309c is exemplified.

In the third embodiment, the case where the head 202 (percussion surface) is provided in a space surrounded by the fixing part 310a and the arced part 211 of the first frame 301a, and the percussion to the head 202 is detected by using the head sensor S1 (which is a sensor installed to the support frame 204 and indirectly supported by the first frame 301a via the support frame 204 and the base frame 205) is described. However, the invention is not limited thereto.

For example, it may also be that the head 202 (the elastic body 203), the support frame 204, and the base frame 205 are omitted, a plate-shaped first frame is formed to block the space formed by the fixing part 310a and the arced part 211, and the sensor S1 is installed to the first frame. That is, it may also be configured that a percussion surface corresponding to the head 202 is formed by the upper surface of the plate-shaped first frame (or a buffering cover made of rubber, etc., and covering such upper surface), and the first frame directly supports a sensor for detecting the vibration at the time of the percussion to the percussion surface. That is, it may also be configured that the head 202 and the first frame 301a are integrated.

### REFERENCE SIGNS LIST

300: Electronic percussion instrument;
301a: First frame;
311a: Insertion hole;
313a: Fixing protrusion;
316a, 137a: Restricting wall (rotation restriction part);
301b: Second frame;
309a to 309c: Elastic body;
390: Through hole (fitting hole);
393: Buffering protrusion (contact restriction part);
394: Groove;
500: Rod;
B4: Bolt;
S1: Sensor.

1. An electronic percussion instrument, having, on an upper surface, a percussion surface that receives a percussion and a non-percussion surface that is not assumed to receive the percussion, the electronic percussion instrument comprising:
a sensor, detecting a vibration of the percussion to the percussion surface;
a first frame, forming a skeleton of the percussion surface;
an elastic body, fixed to the first frame; and
a second frame, which is connected with the first frame via the elastic body, and to which a sensor is not installed,
wherein the non-percussion surface is formed by an upper surface of the second frame.

2. The electronic percussion instrument as claimed in claim 1, comprising: a plurality of elastic bodies, supported in a cantilevered state by the first frame by having an end side fixed to the first frame,
wherein the second frame is fixed to an other end side of the elastic bodies.

3. The electronic percussion instrument as claimed in claim 2, wherein the first frame comprises an insertion hole for a rod to be inserted, and
each of the elastic bodies extends radially with the insertion hole as a center.

4. The electronic percussion instrument as claimed in claim 2, comprising: the elastic body, fixed to an upper surface side of the first frame by using a bolt; and a contact restriction part, restricting a contact between the bolts and the second frame.

5. The electronic percussion instrument as claimed in claim 4, wherein the contact restriction part is formed by a plurality of protrusions erected from the elastic body toward a side of the second frame and surrounding the bolt.

6. The electronic percussion instrument as claimed in claim 5, wherein the protrusion comprises a groove formed on an outer circumferential surface on a side opposite to the bolt and extending in a direction around an axis of the bolt.

7. The electronic percussion instrument as claimed in claim 2, wherein the elastic body comprises a fitting hole formed on an end side of the elastic body, and
the first frame comprises: a fixing protrusion, inserted into the fitting hole and provided for setting a fixing position of the elastic body; and a rotation restriction part, restricting rotation of the elastic body with respect to the fixing protrusion.

8. The electronic percussion instrument as claimed in claim 7, wherein the rotation of the elastic body with respect to the fixing protrusion is restricted through contact between the rotation restriction part having a wall shape erected from an upper surface of the first frame and an outer circumferential surface of the elastic body.

9. The electronic percussion instrument as claimed in claim 1, wherein the percussion surface and the first frame are formed integrally.

10. A non-percussion surface forming method, which is a non-percussion surface forming method for an electronic percussion instrument having, on an upper surface, a percussion surface that receives a percussion and a non-percussion surface not assumed to receive the percussion, the electronic percussion instrument comprising:
a sensor, detecting a vibration of the percussion to the percussion surface;
a first frame, forming a skeleton of the percussion surface;
an elastic body, fixed to the first frame; and
a second frame, which is connected with the first frame via the elastic body, and to which a sensor is not installed, wherein in the non-percussion surface forming method,
the non-percussion surface is formed by an upper surface of the second frame.

11. An electronic percussion instrument, in which a portion of an upper surface is configured as a percussion surface receiving a percussion, the electronic percussion instrument comprising:
a first member, on an upper surface side of which the percussion surface is formed;
a sensor, detecting the percussion to the percussion surface;
an elastic body, fixed to the first member; and
a second member, which is connected with the first member via the elastic body.
